(19) United States
(12) Patent Application Publication
(10) Pub. No.: US 2026/0322925 A1
(43) Pub. Date: Oct. 15, 2026

(54) ELECTRONIC APPARATUS, INFORMATION PROCESSING SYSTEM, INFORMATION PROCESSING METHOD, AND NON-TRANSITORY RECORDING MEDIUM

(71) Applicant: PFU Limited, ISHIKAWA (JP)

(72) Inventors: Kaho ONOUE, ISHIKAWA (JP); Tomoaki WADA, ISHIKAWA (JP); Hina MIYAZAKI, ISHIKAWA (JP)

(21) Appl. No.: 19/461,825

(22) Filed: Jan. 28, 2026

(30) Foreign Application Priority Data
Feb. 4, 2025 (JP) 2025-016826
Oct. 14, 2025 (JP) 2025-173020

(51) Int. Cl. H04N 1/00

(52) U.S. Cl. CPC H04N 1/00482; H04N 1/00413; H04N 1/00506; H04N 1/00204

(57) ABSTRACT

An electronic apparatus includes circuitry to generate screen information for setting a job that causes the electronic apparatus to execute a plurality of processes in a predetermined order, each classified into a function among a plurality of functions of the electronic apparatus, the screen information causing a display to display one or more screens including: first areas each representing a function among the plurality of functions and being arranged in an execution order of the plurality of functions; second areas each representing a process among the plurality of processes and being arranged in an execution order of the plurality of processes inside the respective first areas each representing the function into which the process represented by each of the second areas is classified; and an input field for receiving setting information indicating whether to execute the plurality of processes or description of the plurality of processes.

### CROSS-REFERENCE TO RELATED APPLICATIONS

This patent application is based on and claims priority pursuant to 35 U.S.C. §119(a) to Japanese Patent Application No. 2025-016826, filed on Feb. 4, 2025, and Japanese Patent Application No. 2025-173020, filed on Oct. 14, 2025, in the Japan Patent Office, the entire disclosures of which are hereby incorporated by reference herein.

### BACKGROUND

The present disclosure relates to an electronic apparatus, an information processing system, an information processing method, and a non-transitory recording medium.

There is a technique for setting a job that causes an electronic apparatus to execute a plurality of processes. For example, a job definition apparatus displays a data flow diagram on a data flow definition window and a job definition table on a job definition window. In the data flow diagram, a plurality of processing step items are linked to each other. In response to processing step items desired to be defined as a job being dragged and dropped from the data flow diagram to the job definition table, the job definition apparatus sequentially places the plurality of processing step items at respective dropped positions on the job definition table.

### SUMMARY

The electronic apparatus according to one aspect of the present disclosure includes circuitry that generates screen information for setting a job that causes the electronic apparatus to execute a plurality of processes in a predetermined order, the plurality of processes being each classified into a function among a plurality of functions of the electronic apparatus. The screen information causes a display to display one or more screens including: first areas each representing a function among the plurality of functions, the first areas being arranged in an execution order of the plurality of functions; second areas each representing a process among the plurality of processes, the second areas being arranged in an execution order of the plurality of processes inside the respective first areas each representing the function into which the process represented by each of the second areas is classified; and an input field for receiving setting information indicating whether to execute the plurality of processes or description of the plurality of processes.

The information processing system according to another aspect of the present disclosure includes an information processing system including the above-described electronic apparatus and a user terminal communicably connected with the electronic apparatus via a network, the user terminal including the display configured to display the one or more screens based on the screen information received from the electronic apparatus.

The information processing method according to still another aspect of the present disclosure includes: generating screen information for setting a job that causes an electronic apparatus to execute a plurality of processes in a predetermined order, the plurality of processes being each classified into a function among a plurality of functions of the electronic apparatus; and displaying one or more screens on a display based on the screen information. The screen includes: first areas each representing a function among the plurality of functions, the first areas being arranged in an execution order of the plurality of functions; second areas each representing a process among the plurality of processes, the second areas being arranged in an execution order of the plurality of processes inside the respective first areas each representing the function into which the process represented by each of the second areas is classified; and an input field for receiving setting information indicating whether to execute the plurality of processes or description of the plurality of processes.

The non-transitory recording medium according to still another aspect of the present disclosure stores a plurality of instructions which, when executed by one or more processors, causes the one or more processors to perform an information processing method including: generating screen information for setting a job that causes an electronic apparatus to execute a plurality of processes in a predetermined order, the plurality of processes being each classified into a function among a plurality of functions of the electronic apparatus; and displaying one or more screens on a display based on the screen information. The screen includes: first areas each representing a function among the plurality of functions, the first areas being arranged in an execution order of the plurality of functions; second areas each representing a process among the plurality of processes, the second areas being arranged in an execution order of the plurality of processes inside the respective first areas each representing the function into which the process represented by each of the second areas is classified; and an input field for receiving setting information indicating whether to execute the plurality of processes or description of the plurality of processes.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram of an example of a general arrangement of a scanner control system;

FIG. 2A is a block diagram illustrating an example of a hardware configuration of a computer;

FIG. 2B is a block diagram illustrating an example of a hardware configuration of a scanner apparatus;

FIG. 3 is a block diagram illustrating an example of a functional configuration of the scanner control system;

FIG. 4 is a diagram illustrating an example of a login screen;

FIG. 5 is a diagram illustrating an example of a home screen;

FIG. 6 is a first diagram illustrating an example of a job setting screen;

FIG. 7 is a second diagram illustrating an example of the job setting screen;

FIG. 8 is a third diagram illustrating an example of the job setting screen;

FIG. 9 is a fourth diagram illustrating an example of the job setting screen;

FIG. 10 is a fifth diagram illustrating an example of the job setting screen;

FIG. 11 is a sixth diagram illustrating an example of the job setting screen;

FIG. 12 is a seventh diagram illustrating an example of the job setting screen;

FIG. 13 is an eighth diagram illustrating an example of the job setting screen;

FIG. 14 is a ninth diagram illustrating an example of the job setting screen;

FIG. 15 is a diagram illustrating an example of a pre-setting screen;

FIG. 16 is a tenth diagram illustrating an example of the job setting screen;

FIG. 17 is an eleventh diagram illustrating an example of the job setting screen;

FIG. 18 is a first diagram illustrating an example of a report screen;

FIG. 19 is a second diagram illustrating an example of the report screen;

FIG. 20 is a first flowchart of an example of a job setting process;

FIG. 21 is a second flowchart of an example of the job setting process;

FIG. 22 is a first sequence diagram illustrating an example of the job setting process;

FIG. 23 is a second sequence diagram illustrating an example of the job setting process;

FIG. 24 is a diagram of an example of a general arrangement of a scanner control system according to a modification;

FIG. 25 is a block diagram illustrating an example of a functional configuration of the scanner control system according to the modification; and

FIG. 26 is a diagram illustrating an example of the job setting screen according to the modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system according to an embodiment of the present disclosure controls an electronic apparatus. The information processing system according to the present embodiment has a function for controlling the electronic apparatus to execute a job. In the present embodiment, the job is an example of a program for executing a plurality of processes in a predetermined order and may be called a profile or a workflow. In the present embodiment, the plurality of processes included in the job are each classified into a function among a plurality of functions. A function may include a group of processes classified based on a timing at which the processes are executed or the purpose for executing the processes.

The information processing system according to the present embodiment further has a function for managing a job to be executed by the electronic apparatus. Management of a job may include setting of a job, execution of the job, and recording or viewing of history information related to setting or execution of the job. Setting of a job may include selection of processes to be included in the job, inputting of parameters related to the processes, and changing of the order of the processes.

The electronic apparatus may be, for example, office equipment, a home appliance, or facility equipment. The electronic apparatus may also be, for example, an image reading apparatus such as a scanner apparatus. The electronic apparatus is not limited to an image reading apparatus. Examples of the electronic apparatus may include an image forming apparatus such as a printer, a facsimile machine, or a digital multifunction peripheral/product/printer (MFP).

In the present embodiment, an example of an information processing system that controls a scanner apparatus, which is an example of an electronic apparatus, will be described. The information processing system according to the present embodiment is hereinafter referred to as a “scanner control system”.

In the present embodiment, a screen for setting a job that causes the electronic apparatus to execute a plurality of processes in a predetermined order is displayed. The plurality of processes are each classified into a function among a plurality of functions. The screen displays first areas each representing a function among the plurality of functions and arranged in an execution order of the plurality of functions, and displays second areas each representing a process among the plurality of processes and arranged in an execution order of the plurality of processes inside the respective first areas each representing the function into which the process represented by each of the second areas is classified. In one aspect of the present embodiment, since the overview of a job is displayed in units of functions and in units of processes, the convenience increases in setting a job.

### General Arrangement

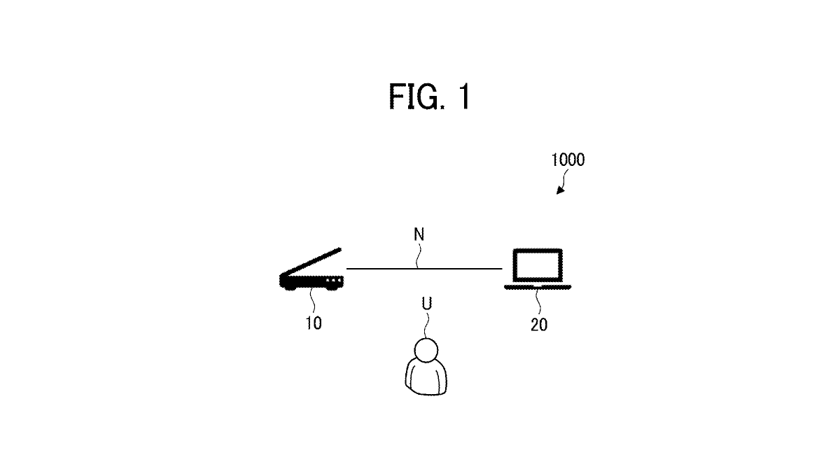

The general arrangement of the scanner control system according to the present embodiment will be described with reference to FIG. 1. FIG. 1 illustrates an example of the general arrangement of the scanner control system.

As illustrated in FIG. 1, a scanner control system 1000 includes a scanner apparatus 10 and a user terminal 20. The scanner apparatus 10 is an example of an electronic apparatus. The user terminal 20 is an example of an information processing apparatus.

The scanner apparatus 10 and the user terminal 20 are connected to each other via a communication network N for data communication. The communication network N may be a wired or wireless communication network or a serial communication network using a Universal Serial Bus (USB) cable. The communication network N may be a part of a communication network such as a local area network (LAN), a virtual private network (VPN), or the Internet.

The scanner apparatus 10 is an example of an image reading apparatus that optically reads an image formed on an image forming medium. The scanner apparatus 10 may output image data read from the image forming medium. The scanner apparatus 10 may perform data processing such as optical character recognition (OCR) on the image data read from the image forming medium and output the processing result. The scanner apparatus 10 may transmit the image data or the processing result of the image data to the user terminal 20 or an external service via the communication network N.

The user terminal 20 is an example of an information processing apparatus such as a personal computer, a smartphone, or a tablet terminal that is operated by a user U of the scanner apparatus 10. The user terminal 20 displays a control software screen serving as a user interface of the scanner control system 1000. The user U operates the control software screen to set a job, execute the job, and view history information related to setting or execution of the job.

In the present embodiment, the user U operates the user terminal 20 to set a job in the scanner apparatus 10, execute the job, and view the history information. In another embodiment, the user U may operate the scanner apparatus 10 to set a job in the scanner apparatus 10, execute the job, and view the history information. The scanner apparatus 10 and the user terminal 20 may be installed in the same space in one embodiment or in different spaces in another embodiment.

The general arrangement of the scanner control system 1000 illustrated in FIG. 1 is an example, and various other system configuration examples may occur in accordance with the use or purpose. For example, the scanner control system 1000 may include two or more scanner apparatuses 10 or two or more user terminals 20. The classification of apparatuses such as the scanner apparatus 10 and the user terminal 20 illustrated in FIG. 1 is an example.

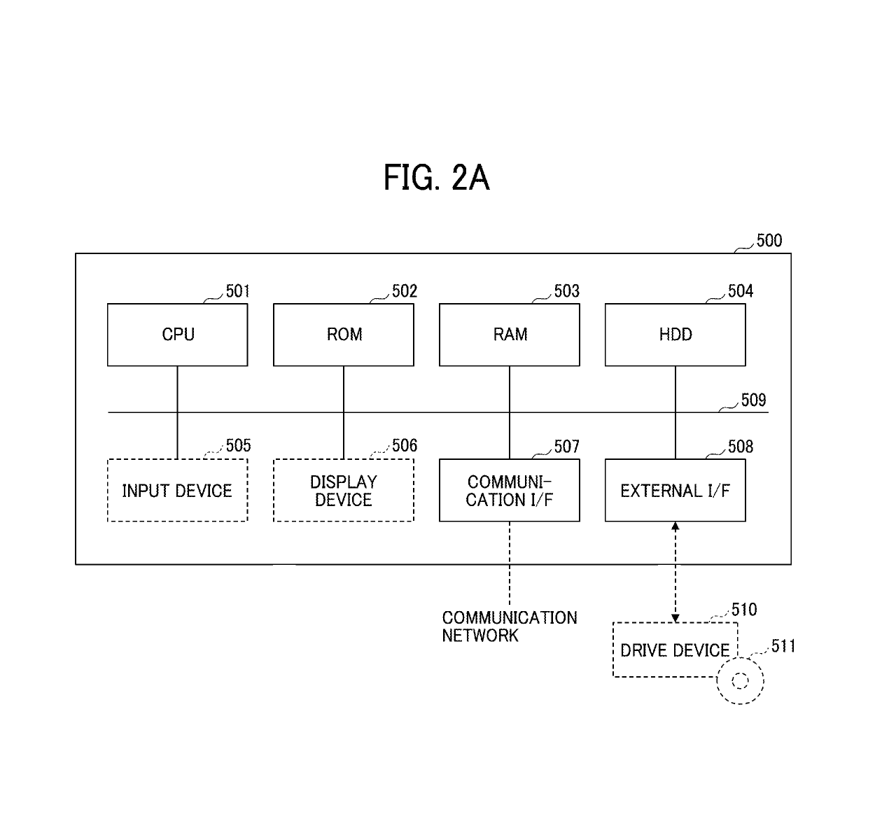

For example, the control software screen may be displayed on a display device 302 (see FIG. 2B described later) of the scanner apparatus 10. In this case, the user U operates the scanner apparatus 10 to set a job in the scanner apparatus 10, execute the job, and view the history information. In this case, the user terminal 20 may be omitted from the scanner control system 1000.

### Hardware Configuration

A hardware configuration of the scanner control system 1000 will be described with reference to FIGS. 2A and 2B.

The user terminal 20 is implemented by, for example, a computer. FIG. 2A is a block diagram illustrating an example of a hardware configuration of the computer.

As illustrated in FIG. 2A, a computer 500 includes a central processing unit (CPU) 501, a read-only memory (ROM) 502, a random access memory (RAM) 503, a hard disk drive (HDD) 504, an input device 505, a display device 506, a communication interface (I/F) 507, and an external I/F 508. The CPU 501, the ROM 502, and the RAM 503 form a processor. The hardware components of the computer 500 are connected to one another via a bus line 509. The computer 500 does not necessarily include the input device 505 and the display device 506. In this case, the external input device 505 and the external display device 506 may be connected to the computer 500 through the external I/F 508.

The CPU 501 reads programs or data from a storage device such as the ROM 502 or the HDD 504 into the RAM 503 and executes processes based on the programs or data to control the computer 500 or implement functions of the computer 500. The computer 500 may include a graphics processing unit (GPU) in addition to or instead of the CPU 501.

The ROM 502 is an example of a nonvolatile semiconductor memory (storage device) that retains programs or data even after the power is turned off. The ROM 502 functions as a main storage device that stores various programs and data used by the CPU 501 to execute the various programs installed on the HDD 504. Specifically, the ROM 502 stores boot programs such as a basic input/output system (BIOS) and an extensible firmware interface (EFI), which are executed at the time of booting the computer 500, and data such as operating system (OS) settings and network settings.

The RAM 503 is an example of a volatile semiconductor memory (storage device) from which programs and data are erased when the power is turned off. The RAM 503 is, for example, a dynamic random access memory (DRAM) or a static random access memory (SRAM). The RAM 503 provides a work area for loading the various programs installed on the HDD 504 when the various programs are executed by the CPU 501.

The HDD 504 is an example of a nonvolatile storage device that stores programs or data. The programs or data stored in the HDD 504 include an OS that is basic software for controlling the entire computer 500 and applications that provide various functions on the OS. The computer 500 may use a storage device (e.g., a solid-state drive (SSD)) that uses a flash memory as a storage medium, instead of the HDD 504.

The input device 505 is used by a user to input various signals. Examples of the input device 505 include a touch panel, operation keys or buttons, a keyboard, a mouse, and a microphone for inputting sound data such as voice.

The display device 506 includes a display such as a liquid crystal display or an organic electroluminescence (EL) display that displays a screen, and a speaker that outputs sound data such as voice.

The communication I/F 507 is an interface for connecting the computer 500 to a communication network to allow the computer 500 to perform data communication.

The external I/F 508 is an interface between the computer 500 and an external device. Examples of the external device include a drive device 510.

The drive device 510 is a device to which a recording medium 511 is placed. Examples of the recording medium 511 include media that optically, electrically, or magnetically record information, such as a compact disc-read-only memory (CD-ROM), a flexible disk, and a magneto-optical disk. Examples of the recording medium 511 may also include a semiconductor memory that electrically records information, such as a ROM or a flash memory. The external I/F 508 allows the computer 500 to read or write data from or to the recording medium 511.

For example, the distributed recording medium 511 may be inserted into the drive device 510 connected to the external I/F 508, and the drive device 510 reads the various programs recorded on the recording medium 511, so that the various programs are installed on the HDD 504. Alternatively, the various programs may be downloaded from another network different from the communication network via the communication I/F 507, so that the various programs are installed on the HDD 504.

FIG. 2B is a block diagram illustrating an example of a hardware configuration of the scanner apparatus 10.

The scanner apparatus 10 includes an operation device 301, the display device 302, an imaging device 303, a motor 304, an interface device 305, a storage device 306, and a processing circuit 307.

The operation device 301 includes an input device such as a button, and an interface circuit that acquires signals from the input device. The operation device 301 receives an input operation performed by a user and outputs an operation signal corresponding to the input operation performed by the user. The display device 302 includes a display such as a liquid crystal display or an organic EL display, and an interface circuit that outputs image data to the display. The display device 302 displays the image data on the display. The operation device 301 and the display device 302 may be integrated together as an operation panel.

The imaging device 303 images a medium conveyed inside the scanner apparatus 10. The imaging device 303 includes, for example, a line sensor including imaging elements, a lens that forms an image onto the imaging elements, and an analog-to-digital (A/D) converter. Under the control of the processing circuit 307, the imaging device 303 images the surface of a medium being conveyed to generate an input image, and outputs the input image.

The motor 304 includes one or more motors. The motor 304 rotates various rollers located inside the scanner apparatus 10 to convey a medium in accordance with a control signal from the processing circuit 307.

The interface device 305 includes an interface circuit that supports a serial bus, such as USB. The interface device 305 electrically connects the scanner apparatus 10 to the user terminal 20 to transmit and receive an input image and various kinds of information to and from the user terminal 20. The interface device 305 may be replaced with a communication device that includes an antenna to transmit and receive radio signals and a wireless communication interface device to transmit and receive signals via a wireless communication line in accordance with a predetermined communication protocol. The predetermined communication protocol is, for example, a wireless LAN communication protocol. The communication device may include a wired communication interface device to transmit and receive signals via a wired communication line in accordance with a communication protocol such as a wired LAN communication protocol.

The storage device 306 includes memory devices such as a RAM and a ROM; a fixed disk device such as a hard disk; or a portable storage device such as a flexible disk or an optical disk. The storage device 306 stores, for example, computer programs, databases, and tables used for various processes performed by the scanner apparatus 10. The computer programs may be installed on the storage device 306 from a computer-readable portable recording medium using, for example, a setup program. The portable recording medium is, for example, a CD-ROM or a digital versatile disc read-only memory (DVD-ROM).

The processing circuit 307 operates based on programs prestored in the storage device 306. The processing circuit 307 is, for example, a CPU. Alternatively, as the processing circuit 307, for example, a digital signal processor (DSP), a large-scale integration (LSI) chip, an application-specific integrated circuit (ASIC), or a field-programmable gate array (FPGA) may be used.

### Functional Configuration

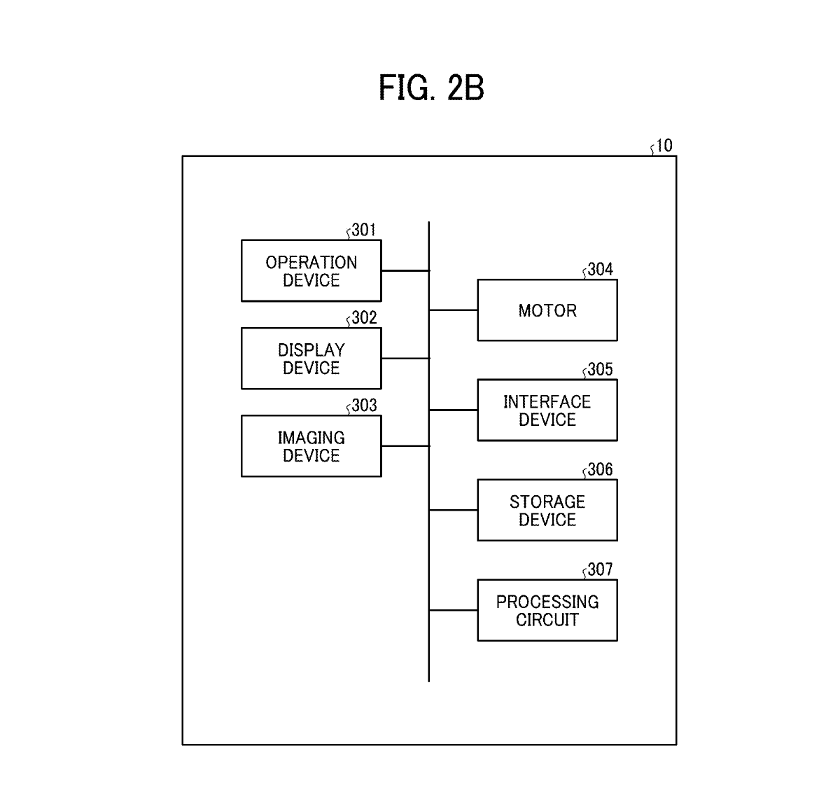

A functional configuration of the scanner control system 1000 will be described with reference to FIG. 3. FIG. 3 is a block diagram illustrating an example of the functional configuration of the scanner control system.

### Scanner Apparatus

As illustrated in FIG. 3, the scanner apparatus 10 includes a storage unit 100, a screen transmission unit 110, a job management unit 120, and a job execution unit 130. The scanner apparatus 10 executes a scanner program preinstalled thereon to function as the storage unit 100, the screen transmission unit 110, the job management unit 120, and the job execution unit 130.

For example, the storage unit 100 is implemented by an auxiliary memory such as a semiconductor memory, which is an example of the storage device 306. For example, the screen transmission unit 110, the job management unit 120, and the job execution unit 130 are implemented by the processing circuit 307 executing a program loaded to a RAM from an HDD, which is an example of the storage device 306 illustrated in FIG. 2B.

The storage unit 100 stores information related to a job. Hereinafter, the information related to a job is also referred to as “job information”. The job information may include definition information that indicates processes possibly included in a job, an execution order of the processes, functions into which the processes are classified, and an execution order of the functions. The job information may include setting information for each of the processes included in the job. The storage unit 100 may store the job information for each set job.

The storage unit 100 stores history information. The history information may include history information related to setting of a job and history information related to execution of the job.

The screen transmission unit 110 transmits screen information. The screen information is used for displaying a screen. In response to a request from the user terminal 20, the screen transmission unit 110 generates screen information and transmits the screen information to the user terminal 20. The screen information is, for example, electronic data written in HyperText Markup Language (HTML), and may include a program written in a script language such as JavaScript®. The screen transmission unit 110 may be implemented by, for example, a web server or an application server.

The screen transmission unit 110 transmits screen information for displaying the control software screen. In the present embodiment, the control software screen includes a login screen, a home screen, a job setting screen, and a report screen.

The job management unit 120 manages a job. In response to a request from the user terminal 20, the job management unit 120 stores job information in the storage unit 100. The job management unit 120 may store history information related to setting of a job in the storage unit 100.

The job execution unit 130 executes a job. More specifically, in response to a request from the user terminal 20, the job execution unit 130 executes a job. The job execution unit 130 may execute a job based on job information read from the storage unit 100. The job execution unit 130 may store history information related to execution of a job in the storage unit 100.

### User Terminal

As illustrated in FIG. 3, the user terminal 20 includes a screen display unit 210 and an operation receiving unit 220. The user terminal 20 executes a terminal program preinstalled thereon to function as the screen display unit 210 and the operation receiving unit 220. The terminal program may be implemented by a function of basic software (i.e., operating system (OS)) installed on the user terminal 20.

For example, the screen display unit 210 and the operation receiving unit 220 are implemented by processes executed by the CPU 501 based on a program loaded to the RAM 503 from the HDD 504 illustrated in FIG. 2A.

The screen display unit 210 displays the control software screen on the display device 506. The screen display unit 210 may display the control software screen based on the screen information received from the scanner apparatus 10. The screen display unit 210 may be a web browser or an application having a browser function. The application having a browser function may be, for example, an application that displays web content using a web viewing function.

The operation receiving unit 220 receives an operation performed by the user U. The operation receiving unit 220 may receive an operation performed on the control software screen displayed by the screen display unit 210. In response to an operation performed by the user U, the operation receiving unit 220 requests the scanner apparatus 10 to set a job. In response to an operation performed by the user U, the operation receiving unit 220 requests the scanner apparatus 10 to execute a job.

The scanner apparatus 10 may include the screen display unit 210 and the operation receiving unit 220. When the scanner apparatus 10 includes the screen display unit 210, the screen display unit 210 displays the control software screen on a display (i.e., the display device 302) of an operation panel of the scanner apparatus 10 based on the screen information generated by the screen transmission unit 110. When the scanner apparatus 10 includes the operation receiving unit 220, the operation receiving unit 220 receives an operation performed by the user U on the control software screen displayed on the display (i.e., the display device 302) of the scanner apparatus 10.

The user terminal 20 may include the storage unit 100, the screen transmission unit 110, the job management unit 120, the screen display unit 210, and the operation receiving unit 220. In this case, the scanner apparatus 10 includes the job execution unit 130 and does not necessarily include the storage unit 100, the screen transmission unit 110, and the job management unit 120. When the user terminal 20 includes the storage unit 100, the storage unit 100 stores job information related to a job set in the scanner apparatus 10. When the user terminal 20 includes the operation receiving unit 220, the operation receiving unit 220 transmits a job execution request to the scanner apparatus 10 based on the job information read from the storage unit 100 in response to an operation performed by the user U. In response to the job execution request from the user terminal 20, the job execution unit 130 of the scanner apparatus 10 executes a job. The job execution unit 130 causes history information related to execution of the job to be stored in the storage unit 100 of the user terminal 20.

The functional configuration of the scanner control system 1000 illustrated in FIG. 3 is an example, and various functional configuration examples may occur in accordance with the use or purpose. The classification of processing units such as the storage unit 100, the screen transmission unit 110, the job management unit 120, the job execution unit 130, the screen display unit 210, and the operation receiving unit 220 illustrated in FIG. 3 is an example.

### User Interfaces

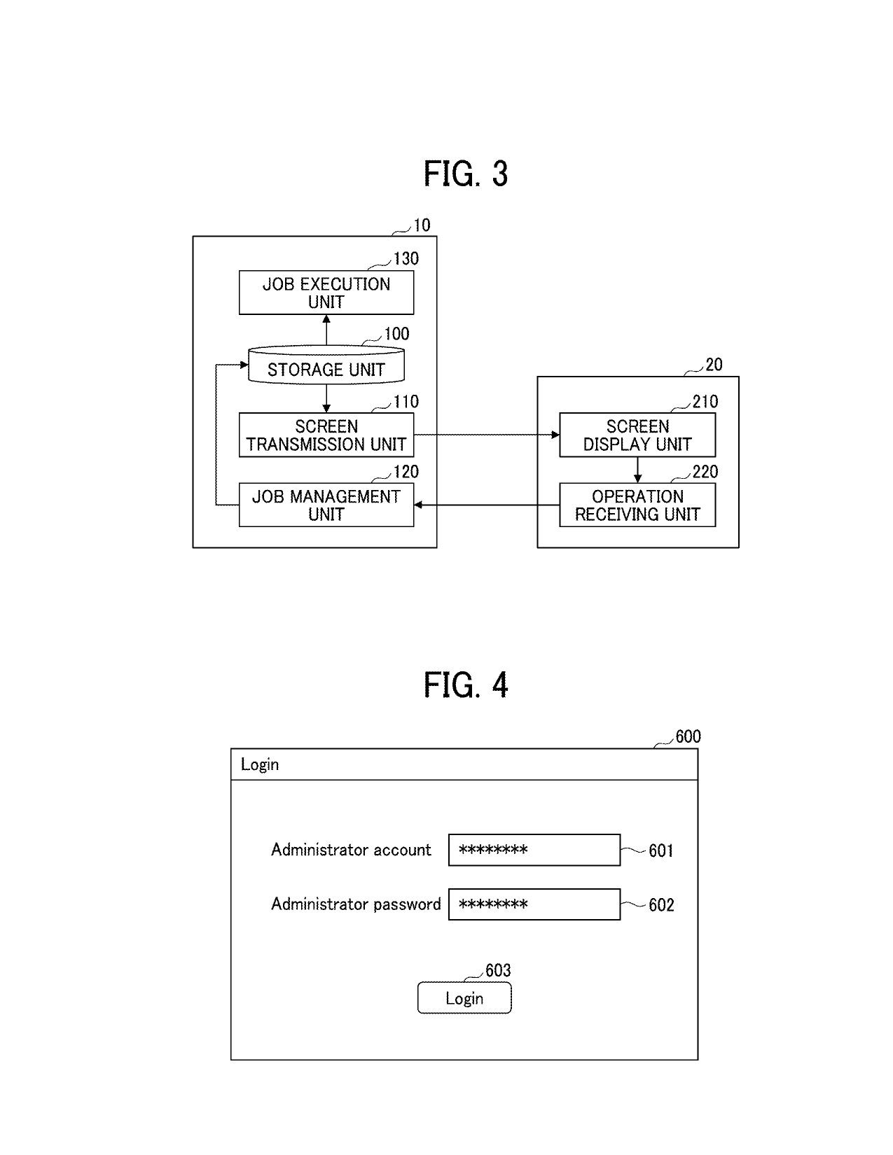

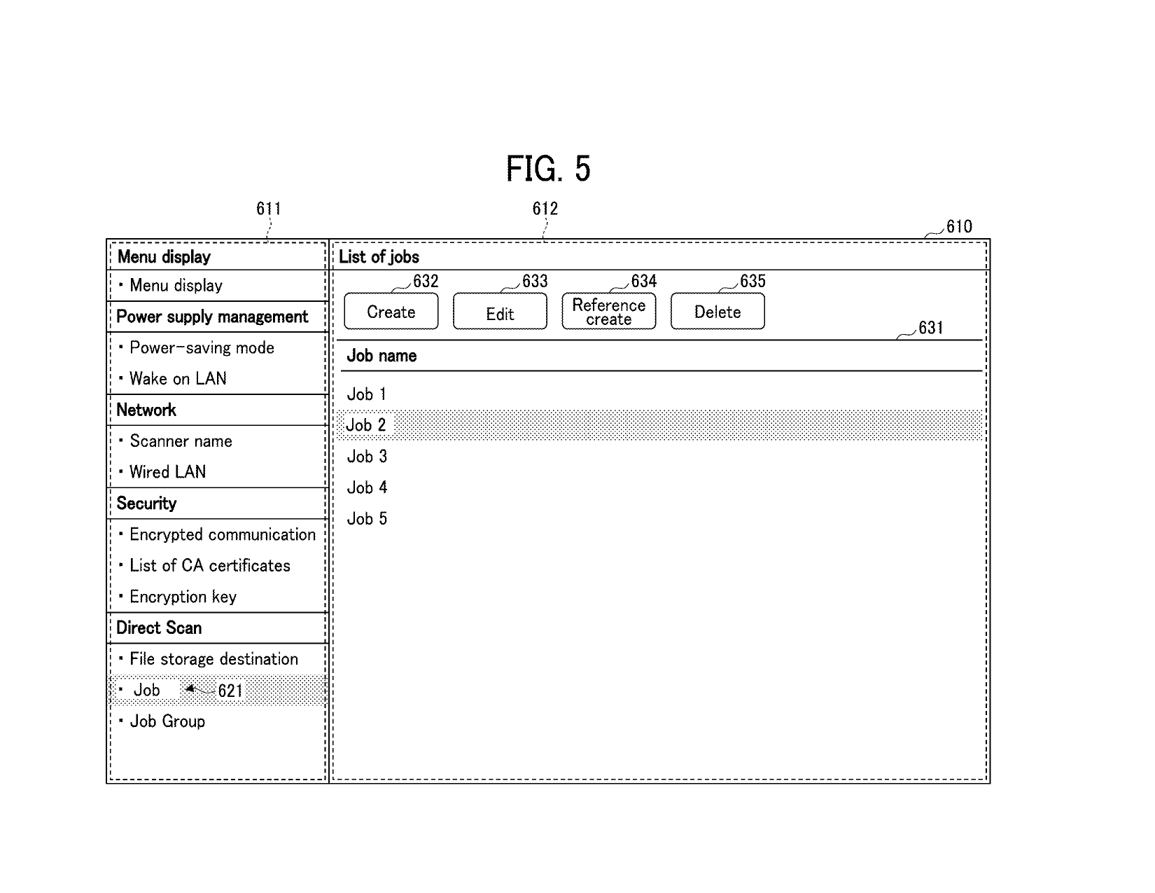

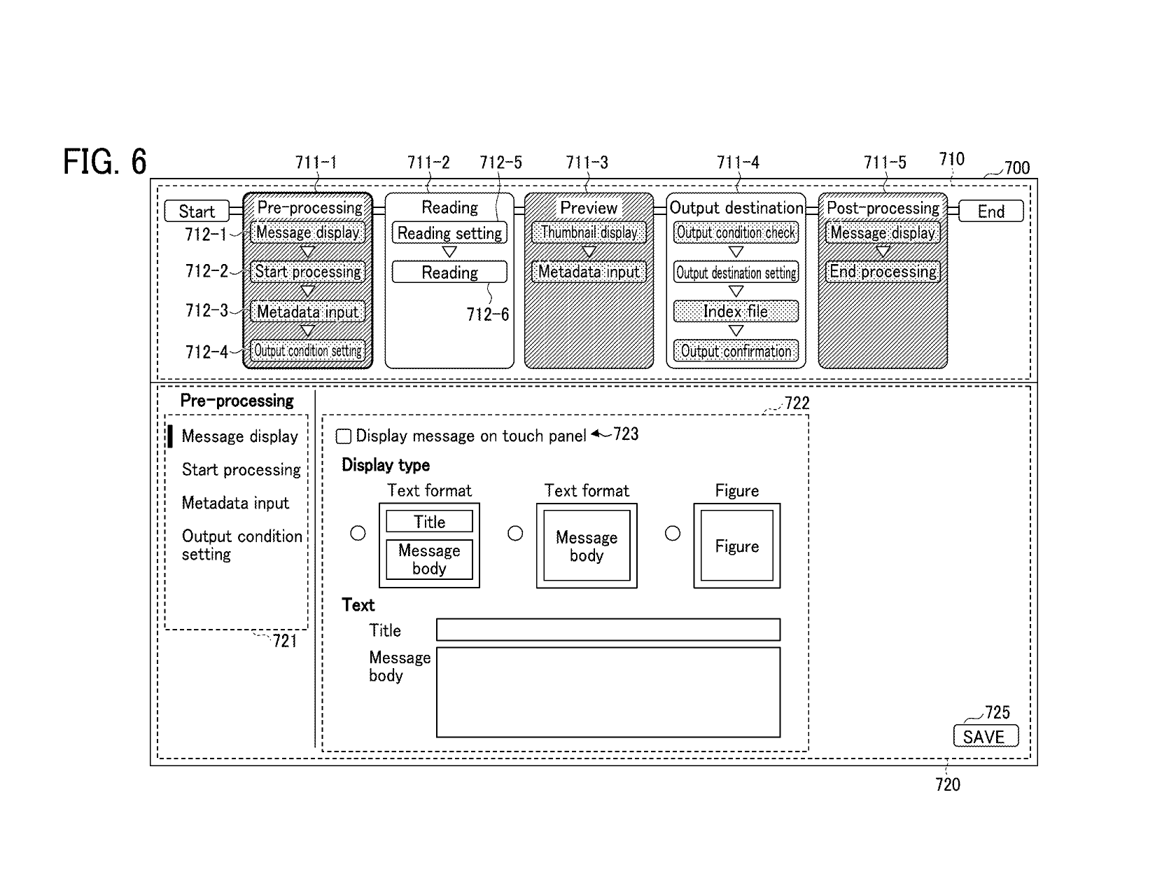

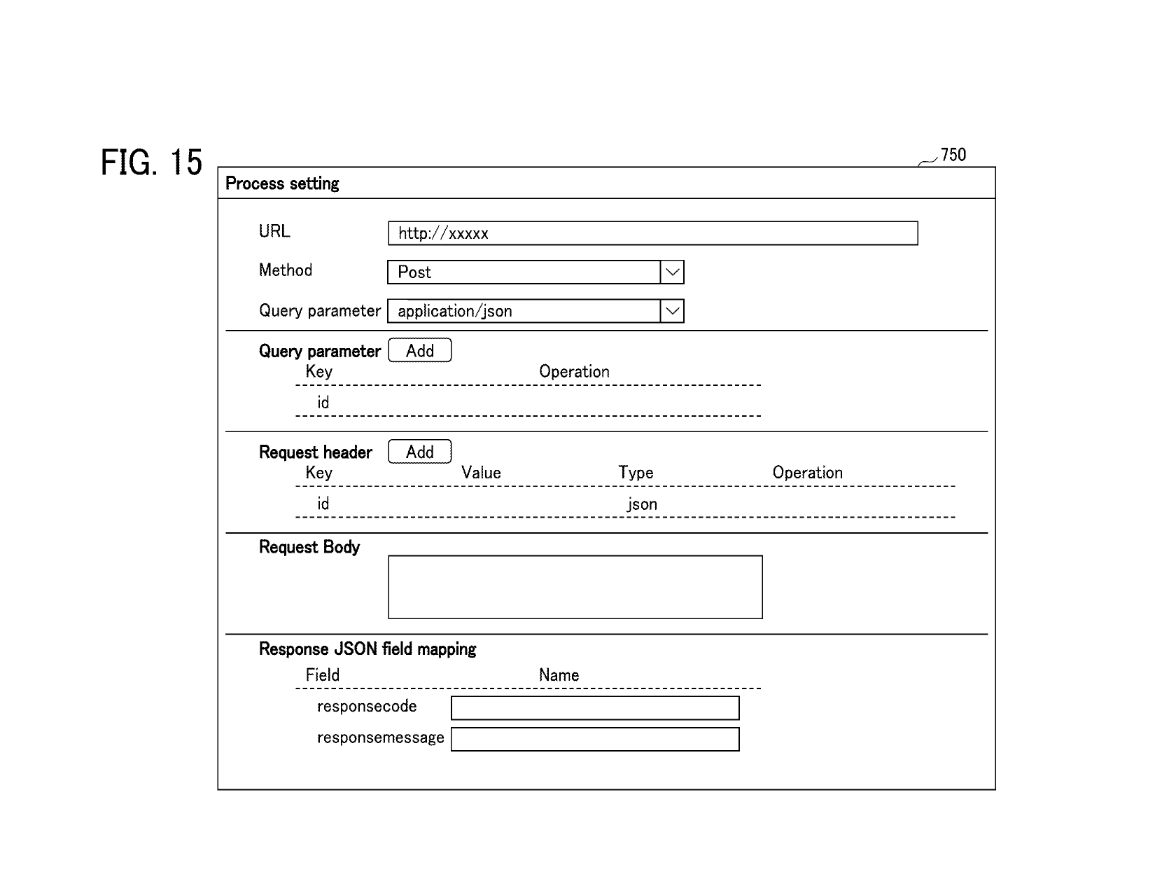

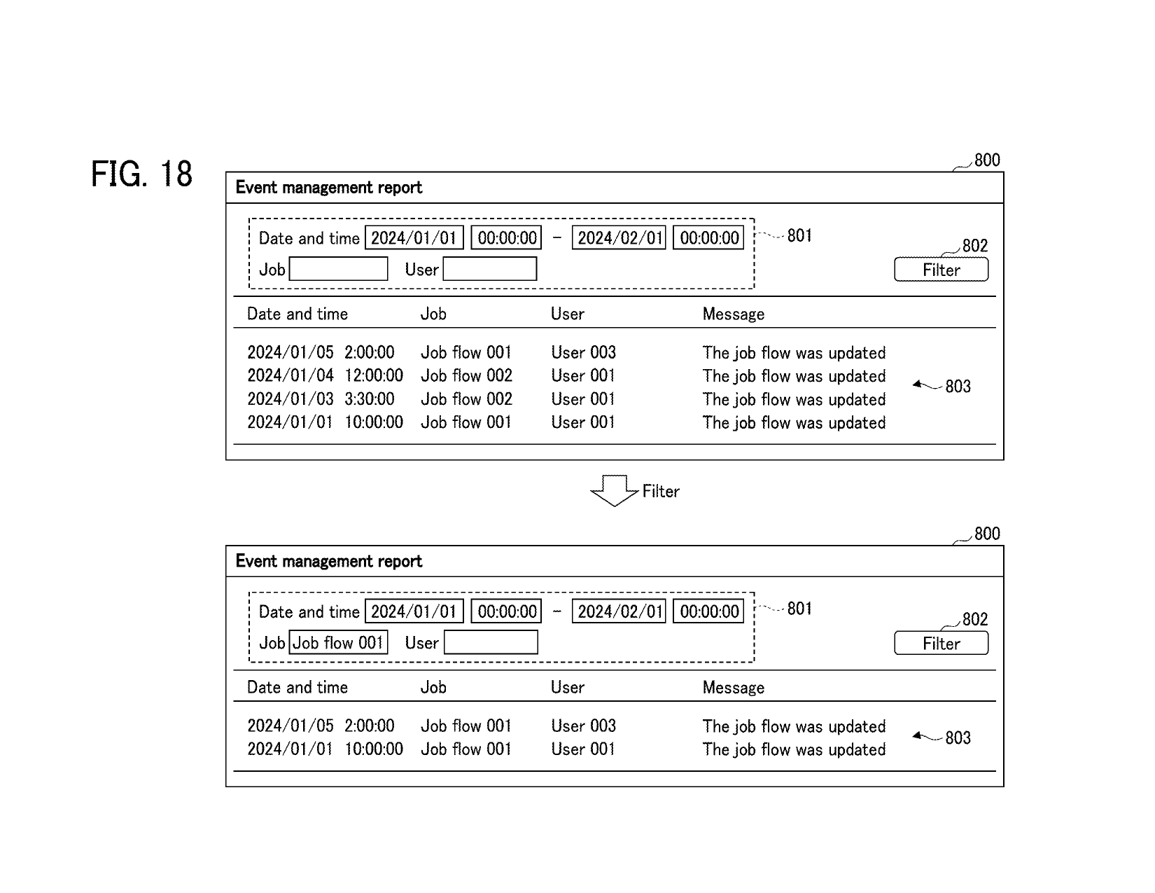

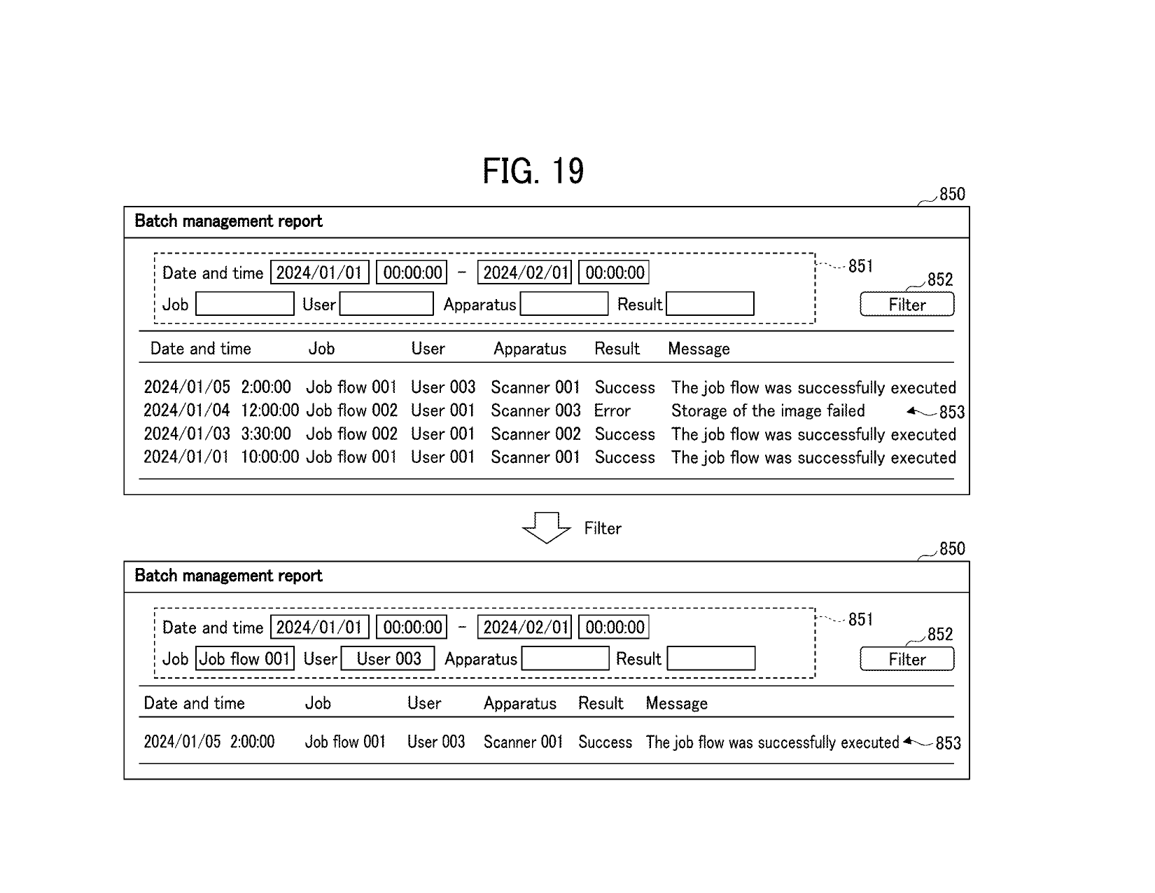

The control software screen serving as a user interface of the scanner control system 1000 will be described with reference to FIGS. 4-19. The control software screen includes a login screen (see FIG. 4), a home screen (see FIG. 5), a job setting screen (see FIGS. 6-14, 16 and 17), a pre-setting screen (see FIG. 15), and a report screen (see FIGS. 18 and 19).

FIG. 4 is a diagram illustrating an example of the login screen. As illustrated in FIG. 4, a login screen 600 includes an account input field 601, a password input field 602, and a login button 603. The account input field 601 receives input of a user account of a user who tries to log in to the scanner control system 1000. The password input field 602 receives input of a password for use in authentication. The user U inputs the user account and the password to the account input field 601 and the password input field 602, respectively, and presses the login button 603, so that authentication of the user U is performed. If the authentication of the user U is successful, the login screen 600 changes to the home screen. While FIG. 4 illustrates the example screen when the user is an administrator, the user who logs in may be a general user such that the example screen may display “user account” and “user password”.

FIG. 5 is a diagram illustrating an example of the home screen. As illustrated in FIG. 5, a home screen 610 includes a menu area 611 and a content area 612.

The menu area 611 displays a list of menus related to control of the scanner apparatus 10. The list of menus includes a job menu 621. In response to selection of the job menu 621, content related to job setting is displayed in the content area 612.

The content related to job setting includes a job display area 631, a create button 632, an edit button 633, a reference create button 634, and a delete button 635. The job display area 631 displays a list of set jobs.

The create button 632 is a button for creating a new job. In response to pressing of the create button 632, the home screen 610 transitions to a job setting screen for creating a new job. The job setting screen may display initial state job setting information.

The edit button 633 is a button for editing a set job. In response to pressing of the edit button 633, the home screen 610 transitions to a job setting screen for editing the setting information of a job. The job setting screen may display the setting information of a set job to be editable. The edit button 633 may be caused to be selectable when one of the jobs is selected in the job display area 631.

The reference create button 634 is a button for creating a job based on reference. Creating a job based on reference refers to an operation for creating a new job based on a set job. In response to pressing of the reference create button 634, the home screen 610 transitions to a job setting screen for creating a job based on reference. The job setting screen may display the setting information of a set job to be editable. The reference create button 634 may be caused to be selectable when one of the jobs is selected in the job display area 631.

The delete button 635 is a button for deleting a set job. In response to pressing of the delete button 635, the job selected in the job display area 631 is deleted. The delete button 635 may be caused to be selectable when one of the jobs is selected in the job display area 631.

FIG. 6 is a first diagram illustrating an example of the job setting screen. As illustrated in FIG. 6, a job setting screen 700 includes an overview screen 710 and a setting screen 720. The overview screen 710 is an example of a first screen. The setting screen 720 is an example of a second screen.

In one example of the job setting screen 700, the overview screen 710 and the setting screen 720 are displayed simultaneously in a screen area of a single display device. In another example, the job setting screen 700 may be displayed such that the overview screen 710 and the setting screen 720 are separately displayed in respective screen areas of two display devices. In yet another example, the job setting screen 700 may be displayed such that the overview screen 710 and the setting screen 720 are separately displayed in two split screen areas of a screen of a single display device.

The overview screen 710 depicts an overview of a job. The overview screen 710 includes one or more function areas 711 (711-1 to 711-5). The function areas 711 are each an area representing a function into which processes executed by the scanner apparatus 10 are classified. The function areas 711 are each an example of a first area.

The overview screen 710 displays the function areas 711 in an execution order of the functions. FIG. 6 illustrates the overview screen 710 in which the function areas 711 are horizontally arranged from left to right. However, the direction in which the function areas 711 are arranged may be determined in any manner. For example, in the overview screen 710, the function areas 711 may be vertically arranged from top to bottom. For example, in the overview screen 710, the function areas 711 may be divided into and displayed as multiple columns or multiple rows.

In the present embodiment, the functions included in a job include, for example, pre-processing, reading, preview, output destination, and post-processing functions. The execution order of the functions included in a job may be determined in advance. In the present embodiment, for example, the pre-processing, reading, preview, output destination, and post-processing functions are executed in this order.

The overview screen 710 includes one or more process areas 712 (712-1 to 712-6). The process areas 712 are each an area representing a process executed by the scanner apparatus 10. Although representative ones among the process areas 712 are denoted by reference signs in FIG. 6, all the rectangular areas located inside the function areas 711-1 to 711-5 are the process areas 712. The process areas 712 are each an example of a second area.

The overview screen 710 displays the process areas 712 inside the respective function areas 711 representing the functions into which the processes represented by the process areas 712 are classified. The overview screen 710 displays the process areas 712 in the execution order of the processes inside each of the function areas 711. FIG. 6 illustrates the overview screen 710 in which the process areas 712 are vertically arranged from top to bottom. However, the direction in which the process areas 712 are arranged may be determined in any manner. For example, in the overview screen 710, the process areas 712 may be horizontally arranged from left to right. For example, in the overview screen 710, the process areas 712 may be divided into and displayed as multiple columns or multiple rows.

In the present embodiment, processes classified into the pre-processing function include, for example, message display, start processing, metadata input, and output condition setting processes. The execution order of the processes included in a job may be determined in advance. In the present embodiment, for example, the message display, start processing, metadata input, and output condition setting processes are executed in this order.

The message display process is a process of displaying a given message on the operation panel of the scanner apparatus 10. The start processing process is a process of performing authentication to execute a job. The metadata input process is a process of inputting information related to the job. The information input in the metadata input process is output together with image data generated by the scanner apparatus 10. The metadata input process may be performed by, for example, directly inputting information or selecting one of the options. The output condition setting process is a process of setting determination conditions used in the execution of the job. The determination conditions include, for example, the expected number of sheets to be read and the upper-limit size of a file. The determination conditions are used in an output condition check process of the output destination function.

In the present embodiment, processes classified into the reading function include, for example, reading setting and reading processes. In the present embodiment, for example, the reading setting and reading processes are executed in this order.

The reading setting process is a process of defining reading settings. The reading settings include a setting item indicating whether to display the reading setting screen on the operation panel. The reading process is a process of causing the scanner apparatus 10 to read an image.

In the present embodiment, processes classified into the preview function include, for example, thumbnail display and metadata input processes. In the present embodiment, for example, the thumbnail display and metadata input processes are executed in this order.

The thumbnail display process is a process of setting whether to display a thumbnail of a read image on the operation panel. The metadata input process is a process of inputting information related to the job. The information input in the metadata input process is output together with image data generated by the scanner apparatus 10. The metadata input process may be performed by, for example, directly inputting information, selecting one of the options, or recognizing a barcode.

In the present embodiment, processes classified into the output destination function include, for example, output condition check, output destination setting, index file, and output confirmation processes. In the present embodiment, for example, the output condition check, output destination setting, index file, and output confirmation processes are executed in this order.

The output condition check process is a process of performing a determination process using the determination conditions set in the output condition setting process of the pre-processing function. The output destination setting process is a process of defining the output destination. The output destination may include, for example, a transmission destination, a path to a storage destination folder, or a file name. The index file process is a process of setting whether to output an index file together with image data. The output confirmation process is a process of setting whether to confirm the output destination or the index file setting on the operation panel before the image data is transmitted to the output destination.

In the present embodiment, processes classified into the post-processing function include, for example, message display and end processing processes. In the present embodiment, for example, the message display and end processing processes are executed in this order.

The message display process is a process of displaying a given message on the operation panel. The end processing process is a process of issuing a job completion notification.

The setting screen 720 is a screen for receiving input of setting information related to a job. The setting screen 720 may receive input of setting information for each process related to the job. The setting screen 720 may collectively receive input of setting information for a plurality of processes related to the job.

The setting screen 720 includes a process list area 721 and a setting input area 722. The process list area 721 displays a list of processes classified into a function subjected to setting. The setting input area 722 displays input fields for receiving setting information related to a process selected in the process list area 721.

The setting screen 720 may receive input of setting information indicating whether to execute the process. FIG. 6 illustrates an example of the setting screen 720 for receiving input of setting information for the message display process classified into the pre-processing function. The setting screen 720 illustrated in FIG. 6 includes a setting item 723 “Display message on touch panel” indicating whether to execute the message display process.

The overview screen 710 displays the process areas 712 representing processes to be executed and the process areas 712 representing processes not to be executed in a different manner. For example, the overview screen 710 may display the process areas 712 representing processes to be executed and the process areas 712 representing processes not to be executed, using different background colors, different font colors, different active states, different icons, different fonts, or different frame lines. The overview screen 710 illustrated in FIG. 6 displays the process areas 712 (e.g., 712-5 and 712-6) representing the processes to be executed using a white background color, and the process areas 712 (e.g., 712-1 to 712-4) representing processes not to be executed using a non-white background color (e.g., gray).

The overview screen 710 displays the function areas 711 for which none of the processes is executed and the function areas 711 for which at least one of the processes is executed in different manners. For example, the overview screen 710 may display the function areas 711 for which none of the processes is executed and the function areas 711 for which at least one process is executed, using different background colors, different font colors, different active states, different icons, different fonts, or different frame lines. The overview screen 710 illustrated in FIG. 6 displays the function areas 711 (e.g., 711-1, 711-3, and 711-5) for which none of the processes is executed using a non-white background color (e.g., gray), and the function areas 711 (e.g., 711-2 and 711-4) for which at least one process is executed using a white background color.

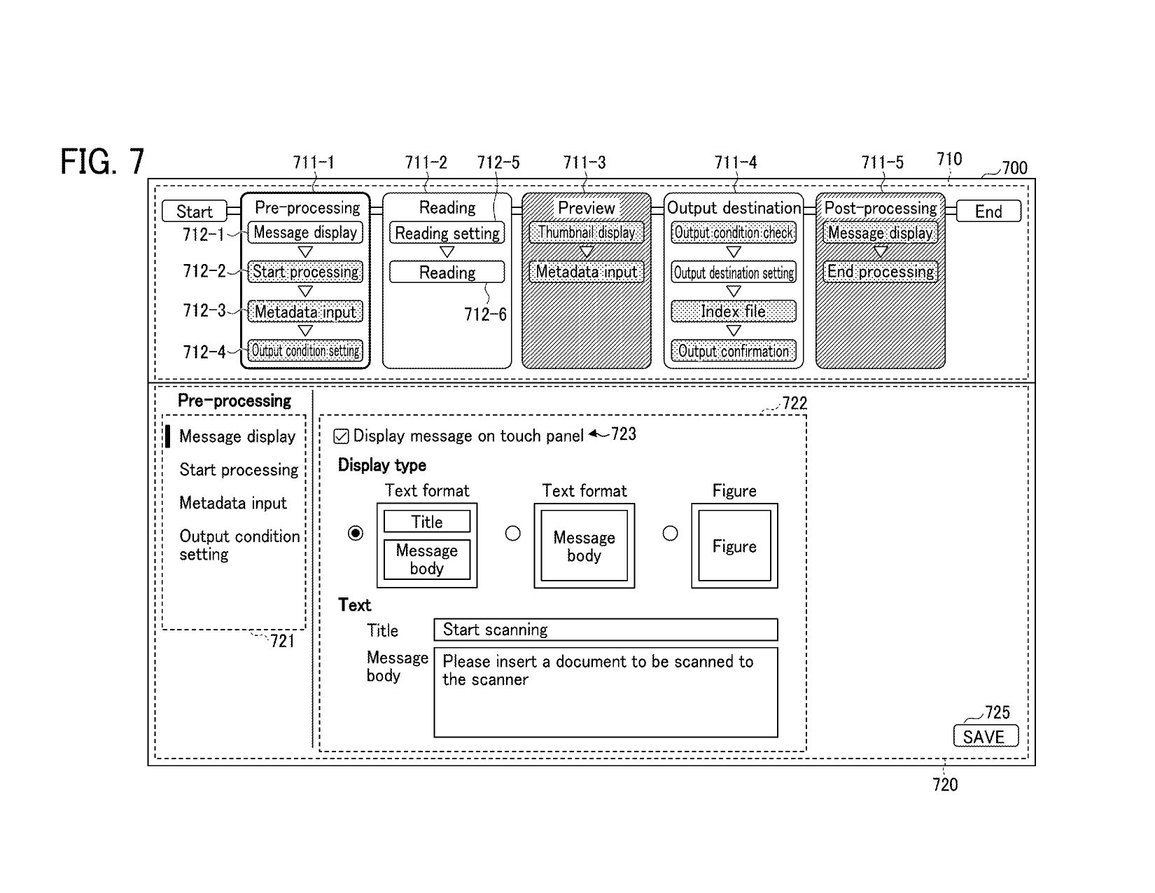

FIG. 7 is a second diagram illustrating an example of the job setting screen. FIG. 7 illustrates an example of the job setting screen 700 in which the setting item 723 is set in the setting screen 720 so that the message display process classified into the pre-processing function is to be executed. Comparison with the job setting screen 700 illustrated in FIG. 6 indicates that the background color of the process area 712-1 representing the message display process is changed in the overview screen 710 illustrated in FIG. 7. The comparison also indicates that the background color of the function area 711-1 representing the pre-processing function is changed in the overview screen 710 illustrated in FIG. 7.

The overview screen 710 may receive an operation performed on one of the process areas 712. For example, the overview screen 710 may receive an operation of selecting one of the process areas 712. The setting screen 720 displays input fields for receiving setting information related to the process represented by the process area 712 operated on the overview screen 710. The setting screen 720 may display input fields for receiving setting information related to a predetermined process in the initial state. The predetermined process may be, for example, the first process in the execution order (e.g., the message display process in the case of the pre-processing function in the present embodiment). Alternatively, the setting screen 720 may display no input fields for receiving setting information in the initial state.

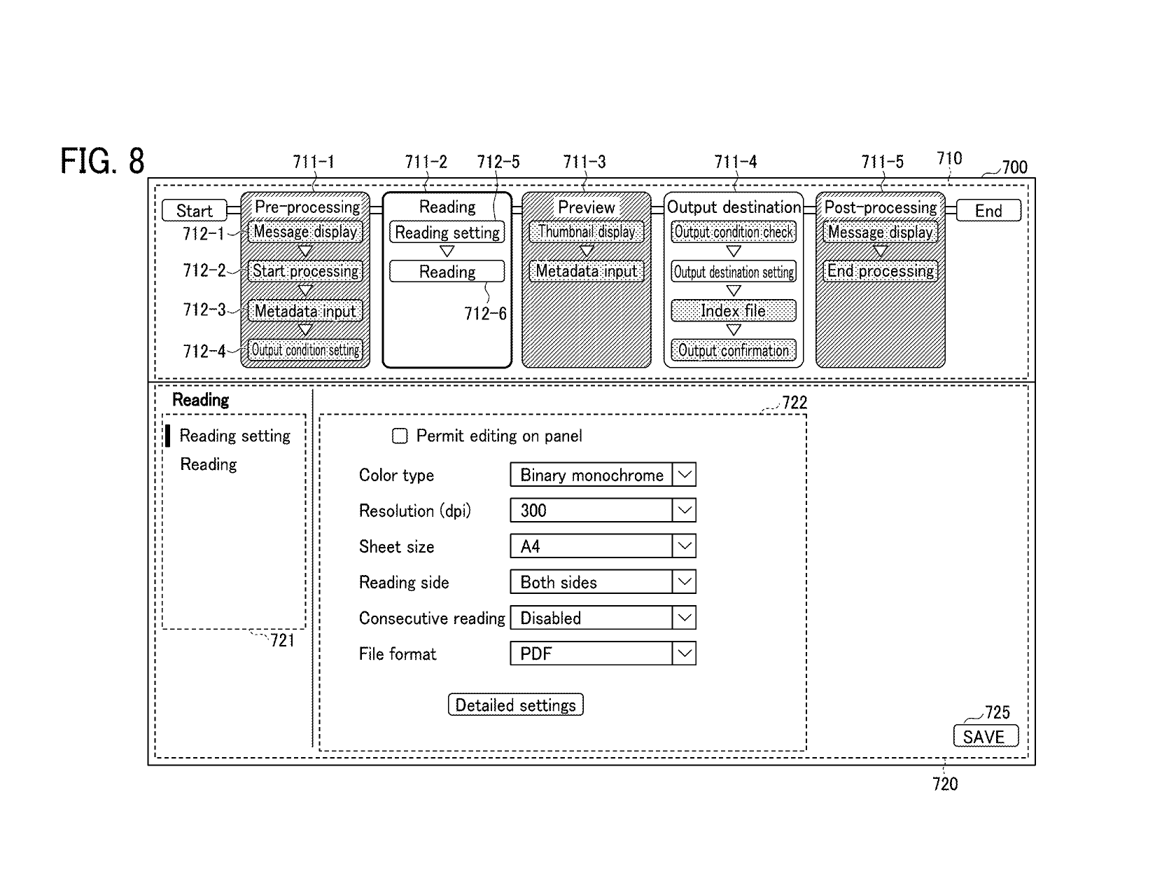

FIG. 8 is a third diagram illustrating an example of the job setting screen. FIG. 8 illustrates an example of the job setting screen 700 displayed when the process area 712-5 representing the reading setting process classified into the reading function is operated on the overview screen 710. As illustrated in FIG. 8, the reading setting process is selected in the process list area 721 and the setting input area 722 displays input fields for receiving setting information related to the reading setting process.

The overview screen 710 may receive an operation on the function area 711. For example, the overview screen 710 may receive an operation of selecting one of the function areas 711. When one of the function areas 711 is operated on the overview screen 710, the setting screen 720 may display input fields for receiving setting information related to all the processes classified into the function represented by the operated function area 711.

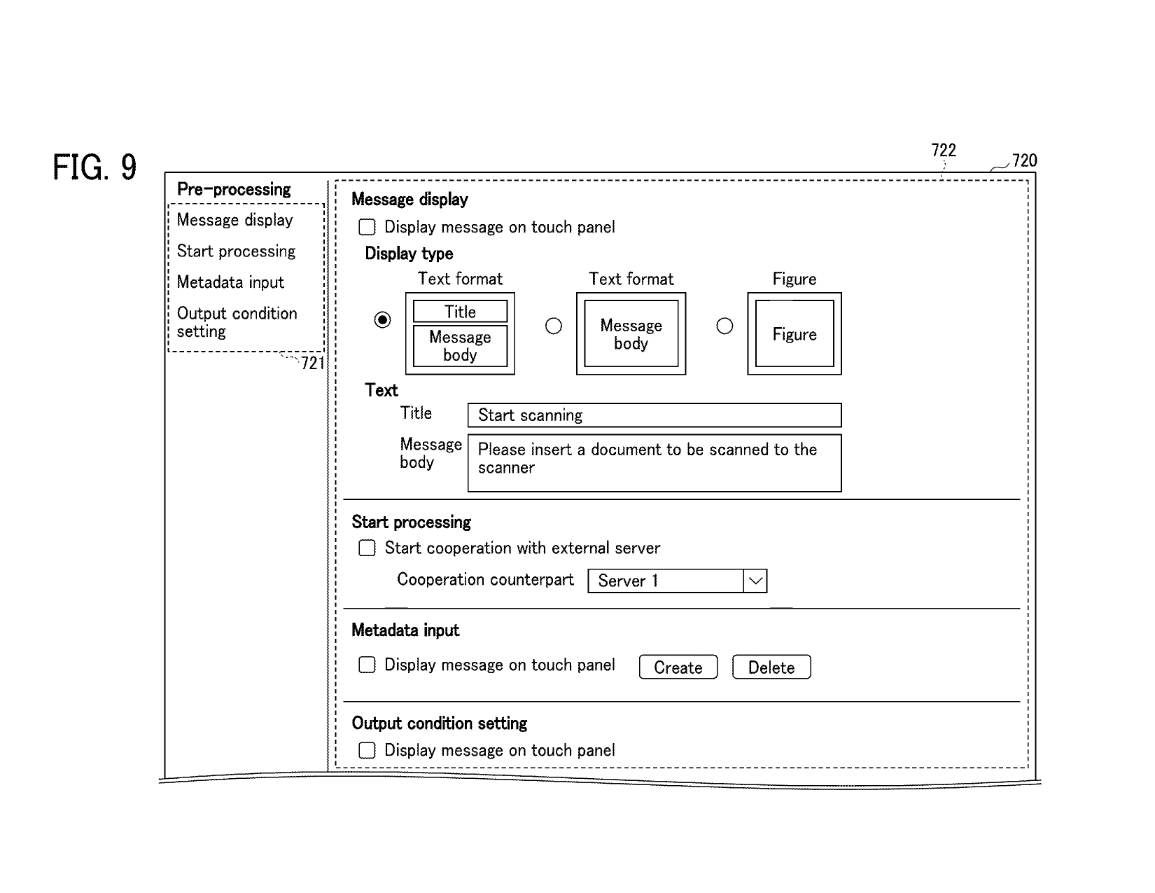

FIG. 9 is a fourth diagram illustrating an example of the job setting screen. FIG. 9 illustrates an example of the job setting screen 700 displayed when the function area 711-1 representing the pre-processing function is operated on the overview screen 710. As illustrated in FIG. 9, none of the processes is selected in the process list area 721, and the setting input area 722 displays all input fields for receiving setting information related to the message display, start processing, metadata input, and output condition setting processes classified into the pre-processing function.

In the overview screen 710 illustrated in FIG. 6, the direction in which the function areas 711 are arranged or the direction in which the process areas 712 are arranged may be changed. For example, the overview screen 710 may receive input to change at least one of the direction in which the function areas 711 are arranged and the direction in which the process areas 712 are arranged. For example, in the overview screen 710, at least one of the direction in which the function areas 711 are arranged and the direction in which the process areas 712 are arranged may be changed in accordance with the display device. In one example, in the overview screen 710, at least one of the direction in which the function areas 711 are arranged and the direction in which the process areas 712 are arranged may be automatically changed in accordance with the size, orientation, or resolution of the display device. For example, in the overview screen 710, at least one of the direction in which the function areas 711 are arranged and the direction in which the process areas 712 are arranged may be changed to allow the overview of the job to be displayed on a single screen without scrolling.

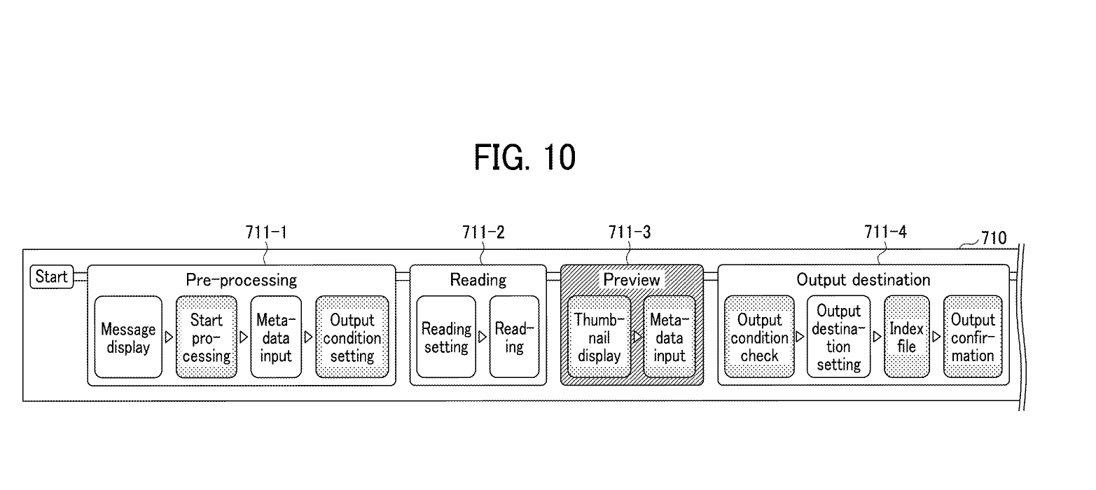

FIG. 10 is a fifth diagram illustrating an example of the job setting screen. FIG. 10 illustrates an example of the overview screen 710 in which the direction in which the process areas 712 are arranged is changed to the horizontal direction. For example, when the display device that displays the overview screen 710 has a large width, the process areas 712 are arranged horizontally. This can increase the height of the setting screen 720 and make input of the setting information easier.

The overview screen 710 illustrated in FIG. 6 displays the process areas 712 representing the processes to be executed using white and displays the process areas 712 representing the processes not to be executed using a non-white color. The overview screen 710 may hide the process areas 712 representing the processes not to be executed and display only the process areas 712 representing the processes to be executed.

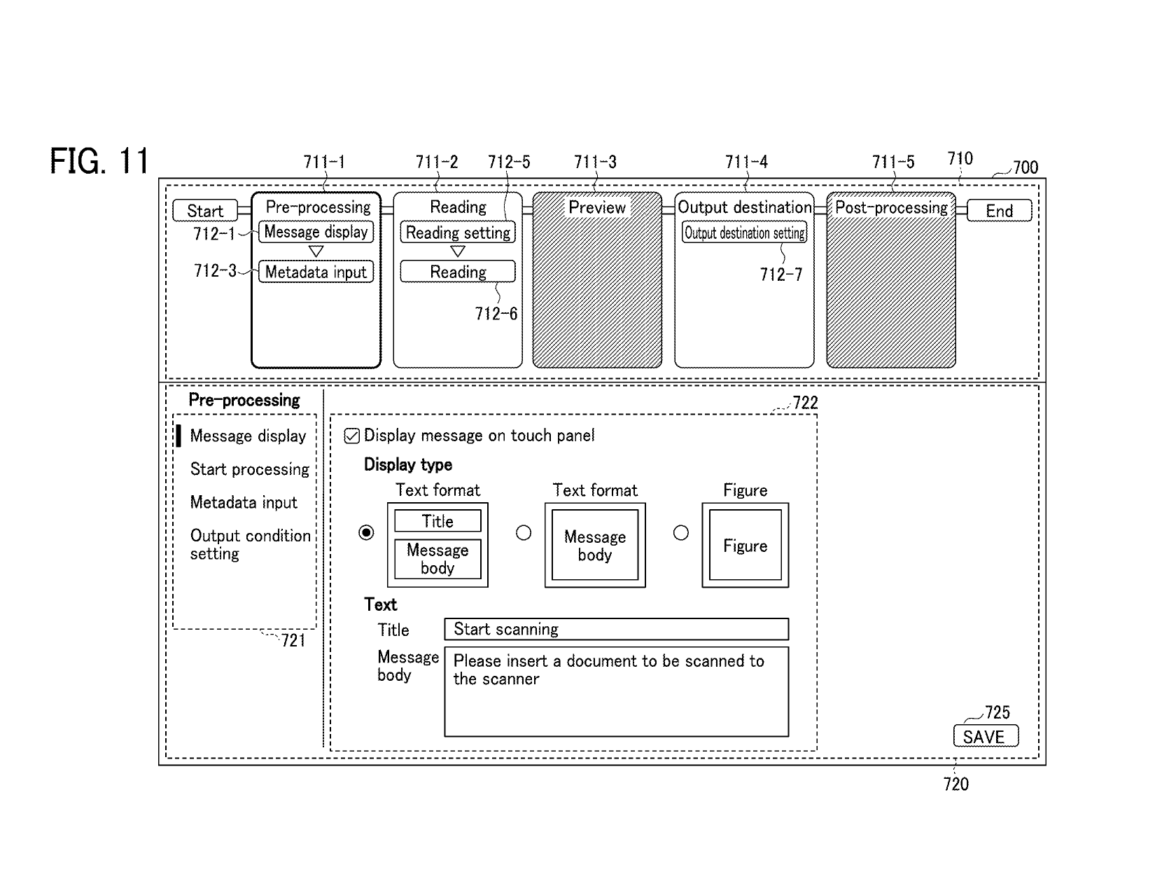

FIG. 11 is a sixth diagram illustrating an example of the job setting screen. FIG. 11 illustrates an example of the job setting screen 700 that displays a job for executing the message display and metadata input processes classified into the pre-processing function, the reading setting and reading processes classified into the reading function, and the output destination setting process classified into the output destination function. As illustrated in FIG. 11, the job setting screen 700 displays the process area 712-1 representing the message display process, the process area 712-3 representing the metadata input process, the process area 712-5 representing the reading setting process, the process area 712-6 representing the reading process, and the process area 712-7 representing the output destination setting process and hides the rest of the process areas 712.

The overview screen 710 illustrated in FIG. 6 displays the function areas 711 for which none of the processes is executed using a non-white color and the function areas 711 for which at least one of the processes is executed using white. The overview screen 710 may hide the function areas 711 for which none of the processes is executed and display only the function areas 711 for which at least one of the processes is executed.

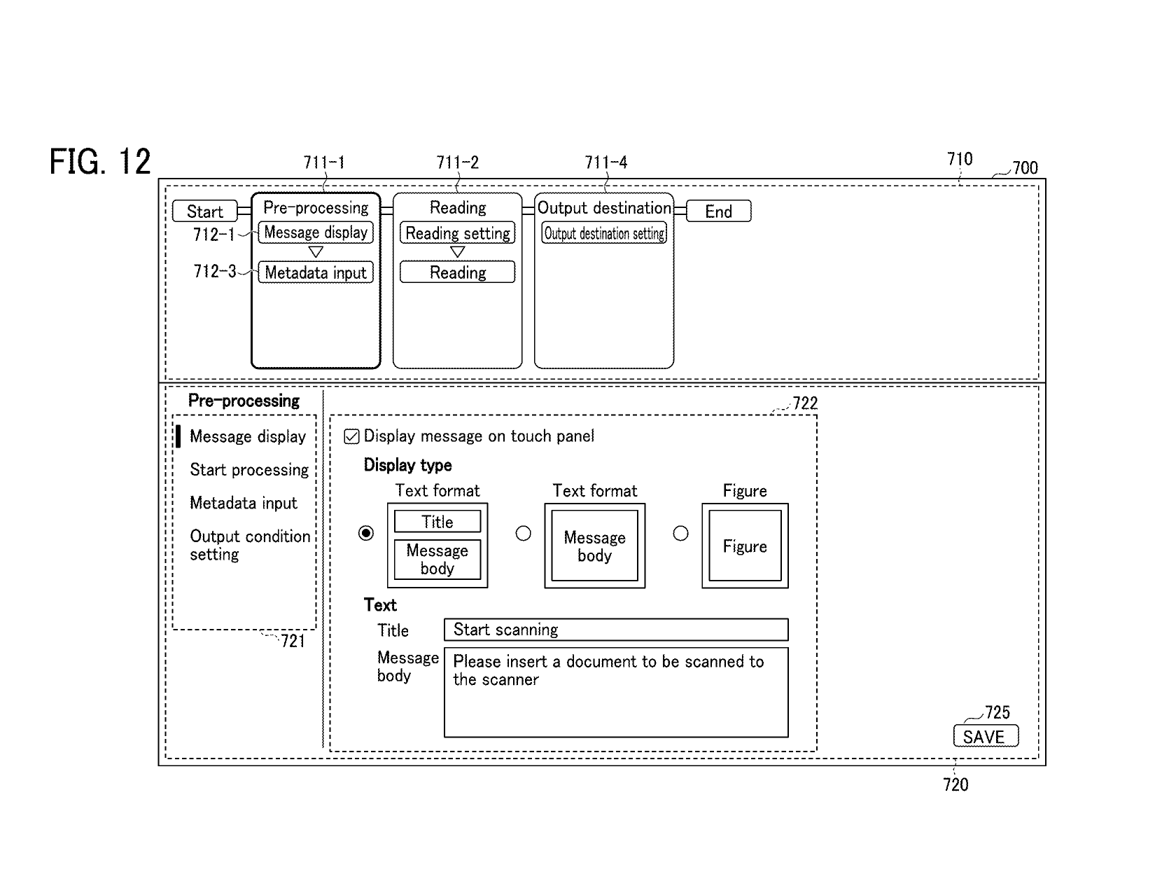

FIG. 12 is a seventh diagram illustrating an example of the job setting screen. FIG. 12 illustrates an example of the job setting screen 700 that hides the function areas 711 for which none of the processes is executed on the job setting screen 700 illustrated in FIG. 11. As illustrated in FIG. 12, the job setting screen 700 displays the function area 711-1 representing the pre-processing function, the function area 711-2 representing the reading function, and the function area 711-4 representing the output destination function and hides the rest of the function areas 711.

The overview screen 710 illustrated in FIG. 6 may receive input to change the execution order of the processes. For example, in response to an operation for moving the position of one of the process areas 712 on the overview screen 710, the order in which the process areas 712 are arranged may be changed. The execution order of the processes in the job may be changed in accordance with the arrangement order of the process areas 712.

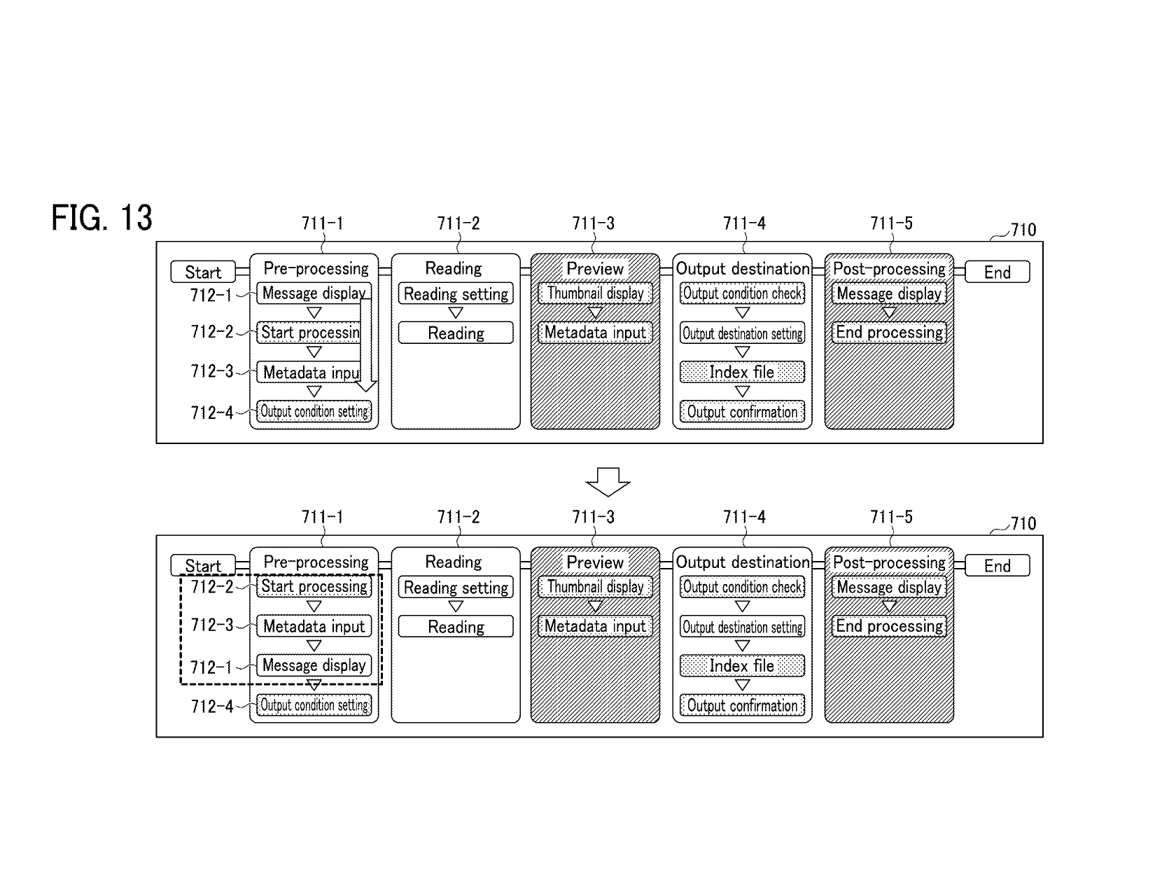

FIG. 13 is an eighth diagram illustrating an example of the job setting screen. FIG. 13 illustrates an example of an operation for changing the execution order of the message display process classified into the pre-processing function so that the message display process is executed after the metadata input process. In FIG. 13, the process area 712-1 representing the message display process is dragged and dropped at a position below the process area 712-3 representing the metadata input process. Consequently, the process area 712-1 representing the message display process is moved to a position between the process area 712-3 representing the metadata input process and the process area 712-4 representing the output condition setting process. In this manner, the job in which the processes classified into the pre-processing function are executed in the order of the start processing, metadata input, message display, and output condition setting processes is set. The execution order of the processes may be changed within the same function or across the plurality of functions.

The overview screen 710 illustrated in FIG. 6 may receive input to add an existing process. The existing process indicates a process that has already been defined in a job. For example, an add button may be provided near the process areas 712. In response to pressing of the add button, a list of existing processes is displayed. In response to selection of a specific process from the list of processes, the process area 712 representing the selected process may be added at the position of the add button.

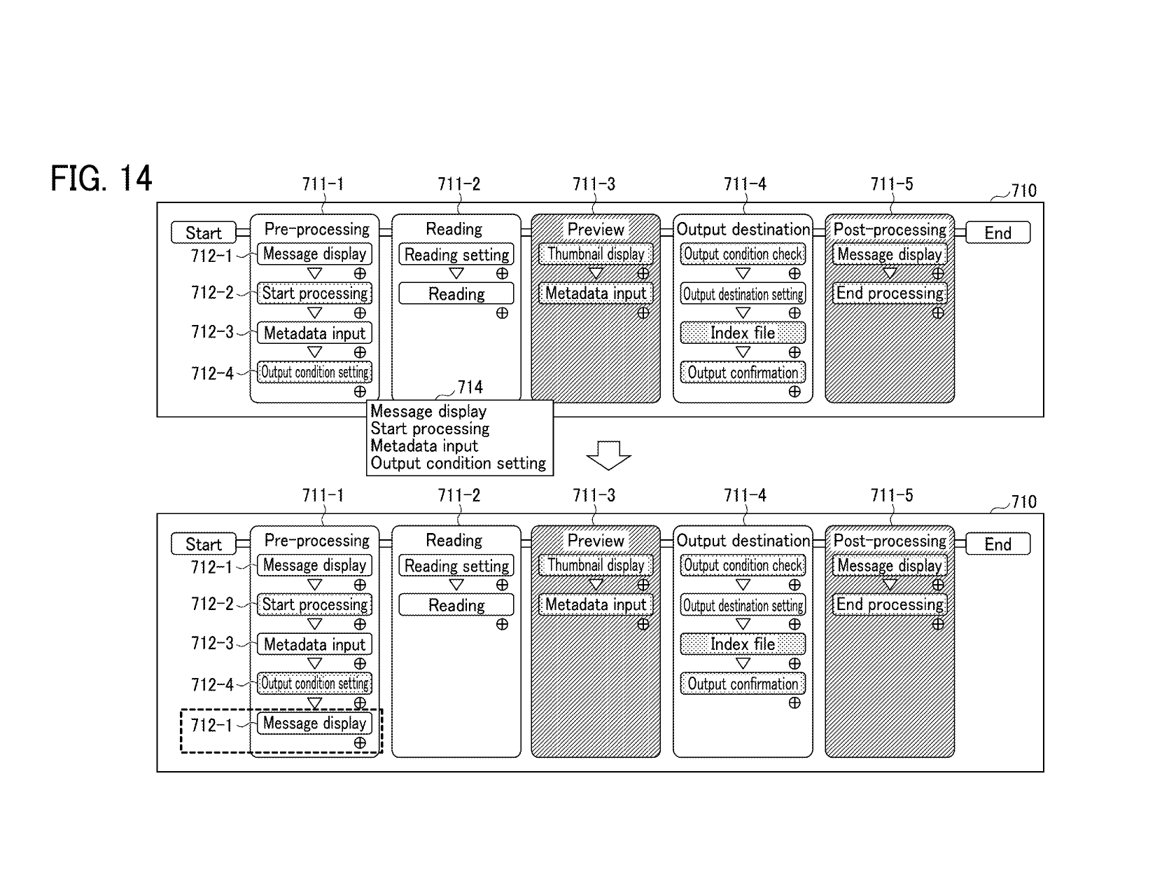

FIG. 14 is a ninth diagram illustrating an example of the job setting screen. FIG. 14 illustrates an example of an operation for adding the message display process after the output condition setting process classified into the pre-processing function. In FIG. 14, an add button 713 is provided below each of the process areas 712. In FIG. 14, a representative add button is denoted by the reference sign. In response to pressing of the add button 713, a context menu 714 is displayed. The context menu 714 displays the list of processes classified into the pre-processing function in a selectable manner. Suppose that the user U selects the message display in the context menu 714. Consequently, the process area 712-1 representing the message display process is added below the process area 712-4 representing the output condition setting process.

The overview screen 710 illustrated in FIG. 6 may receive input to add a given process. The given process indicates a process different from processes that have been defined in a job. For example, the given process may be a process of calling an application programming interface (API) provided by an external information processing apparatus.

As pre-processing for adding the given process, the API may be defined in the control software in advance. The API may be defined in advance, for example, by selecting a menu from the menu area 611 of the home screen 610.

FIG. 15 is a diagram illustrating an example of a pre-setting screen. FIG. 15 illustrates an example of a pre-setting screen for defining an API in advance. As illustrated in FIG. 15, a pre-setting screen 750 displays input fields for receiving setting information used for calling an API. The setting information of an API may include, for example, a Uniform Resource Locator (URL), a method, a query parameter, a request header, a request body, and a response JavaScript Object Notation (JSON) field mapping. The URL, the method, the query parameter, the request header, and the request body are examples of setting information for accessing an information processing apparatus that provides an API. The response JSON field mapping is an example of setting information for acquiring a response to the API.

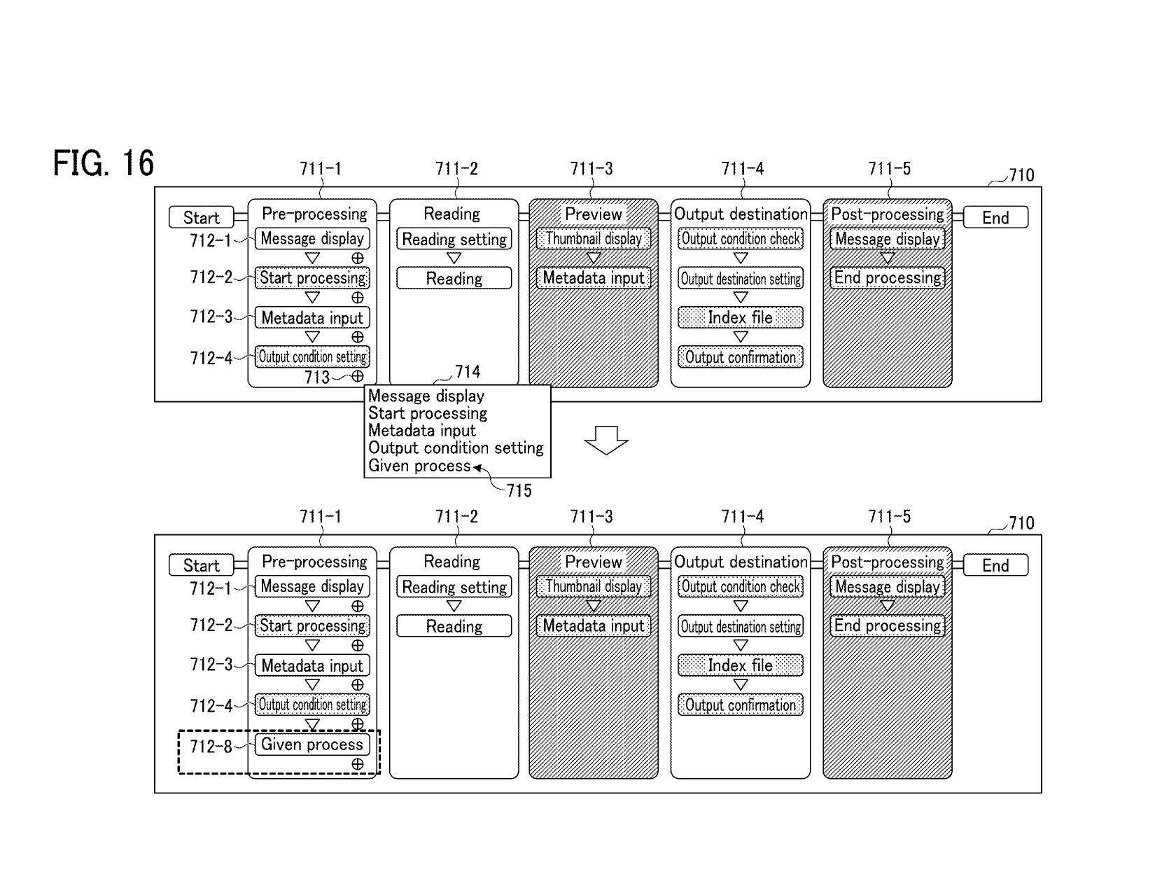

FIG. 16 is a tenth diagram illustrating an example of the job setting screen. FIG. 16 illustrates an example of an operation for adding a given process defined in advance. In FIG. 16, the context menu 714, which is displayed in response to pressing of the add button 713, additionally displays a given process 715. Suppose that the user U selects the given process 715 in the context menu 714. Consequently, the process area 712-8 representing the given process is added below the process area 712-4 representing the output condition setting process.

The setting screen 720 may receive input of setting information for executing a plurality of types of processes. The setting screen 720 may receive selection of a process to be executed among the plurality of types of processes. The plurality of types of processes may include processing content classified into the same process. For example, the plurality of types of processes may be processes that execute common processing content but have different input sources or output destinations.

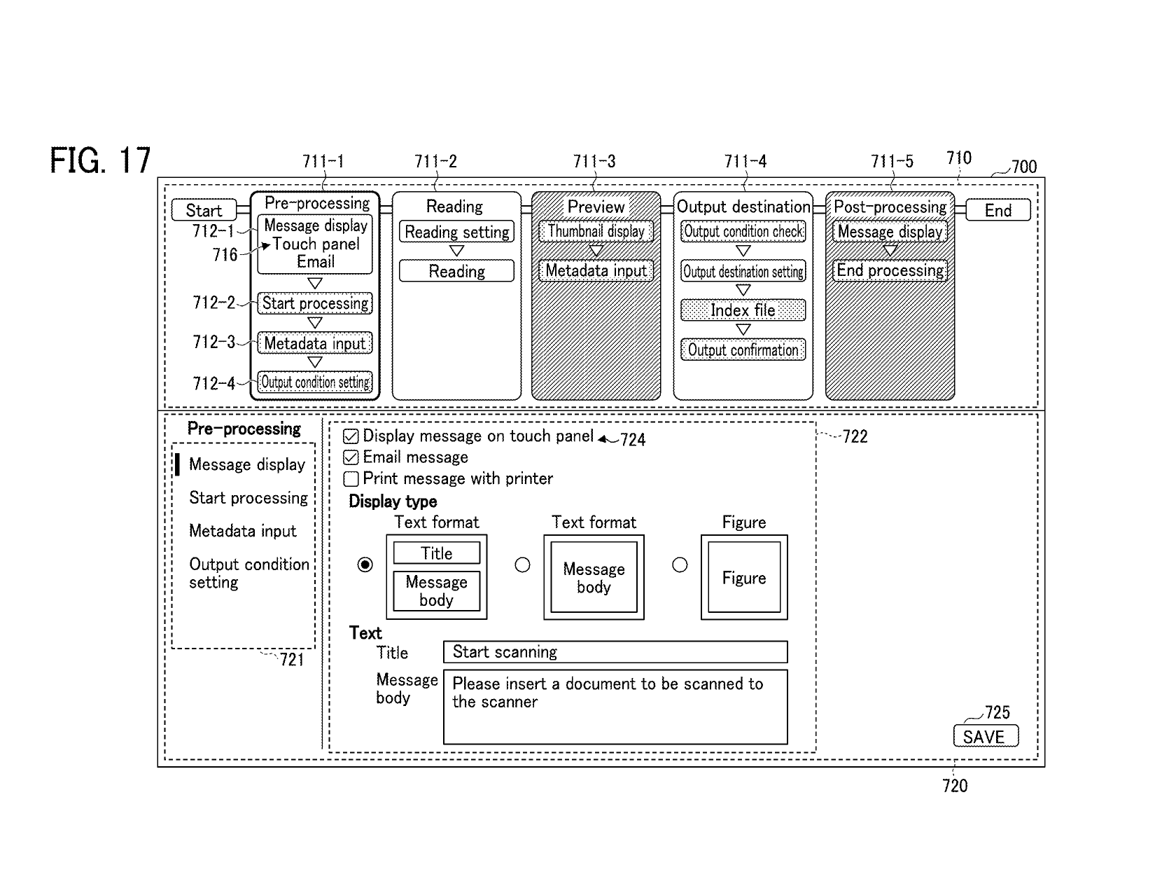

FIG. 17 is an eleventh diagram illustrating an example of the job setting screen. FIG. 17 illustrates an example of the setting screen 720 in which the output destination is selectable from among options of the plurality of kinds of output destinations in the message display process. As illustrated in FIG. 17, the setting screen 720 includes a setting item 724 that allows “touch panel”, “email”, and/or “printer” to be selected as the output destination of the message. The setting item 724 is, for example, a combo box that allows a plurality of output destinations to be selected separately. In the overview screen 710, the process area 712-1 representing the message display process may display output destinations 716 selected with the setting item 724.

FIG. 18 is a first diagram illustrating an example of the report screen. FIG. 18 illustrates an example of a report screen 800 that displays an event management report. The event management report includes a collection of pieces of history information related to job setting.

As illustrated in FIG. 18, the report screen 800 includes a condition input area 801, a filter button 802, and a history display area 803. The history display area 803 displays a list of pieces of history information related to job setting in a time series. The history information may include, for example, a date and time, a job, a user, and a message.

The date and time indicates the date and time when the job was set. The job is information (e.g., job name) indicating the set job. The user is information (e.g., user account input on the login screen 600) indicating the user who set the job. The message is a character string indicating the description of setting of the job. The description of setting of the job includes any description about the setting, and may include, for example, creation, editing (updating), or deletion of the job.

The report screen 800 may display filtered pieces of history information. The condition input area 801 receives input of a filtering condition. The filtering condition may include, for example, the date and time, the job, and/or the user. The filter button 802 is a button for filtering the pieces of history information displayed in the history display area 803 and displaying the filtered pieces of history information. The user U inputs the filtering condition in the condition input area 801 and presses the filter button 802. Then, the pieces of history information meeting the filtering condition are displayed in the history display area 803. FIG. 18 illustrates, for example, the report screen 800 that displays the pieces of history information filtered by the date and time and the job.

FIG. 19 is a second diagram illustrating an example of the report screen. FIG. 19 illustrates an example of a report screen 850 that displays a batch management report. The batch management report includes a collection of pieces of history information related to batch processing of jobs. The batch processing is a function for executing jobs.

As illustrated in FIG. 19, the report screen 850 includes a condition input area 851, a filter button 852, and a history display area 853. The history display area 853 displays a list of pieces of history information related to batch processing of jobs in a time series. The history information may include, for example, a date and time, a job, a user, an apparatus, a result, and a message.

The date and time indicates the date and time when the job was executed. The job is information (e.g., job name) indicating the executed job. The user is information (e.g., user account) indicating the user who executed the job (or registered the batch processing). The apparatus is information (e.g., host name) indicating the scanner apparatus 10 that executed the job. The result indicates whether the job was successfully executed (i.e., success or error). The message is a character string indicating the execution result of the job. When an error occurs in the job, the message may include a character string indicating the description of the error.

The report screen 850 may display filtered pieces of history information. The condition input area 851 receives input of a filtering condition. The filtering condition may include, for example, the date and time, the job, the apparatus, the result, and/or the user. The filter button 852 is a button for filtering the pieces of history information displayed in the history display area 853 and displaying the filtered pieces of history information. The user U inputs the filtering condition in the condition input area 851 and presses the filter button 852. Then, the pieces of history information meeting the filtering condition are displayed in the history display area 853. FIG. 19 illustrates, for example, the report screen 850 that displays the pieces of history information filtered by the date and time, the job, and the user.

### Job Setting Process

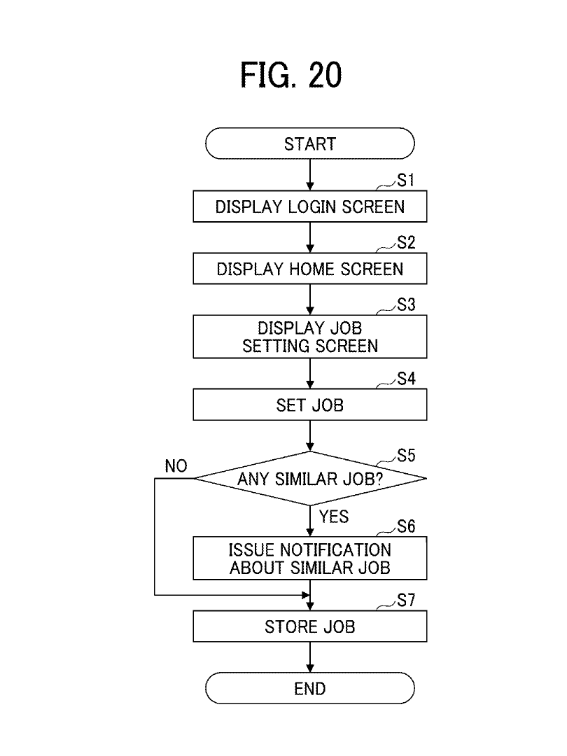

A job setting process executed by the scanner control system 1000 will be described with reference to FIGS. 20 to 23. FIG. 20 is a first flowchart illustrating an example of the job setting process. FIG. 20 illustrates a procedure of the operation of the scanner control system 1000 in the job setting process.

In step S1, the user terminal 20 transmits, to the scanner apparatus 10, a request to acquire the login screen 600 in response to an operation of the user U. In response to the request to acquire the login screen 600, the scanner apparatus 10 transmits screen information of the login screen 600 to the user terminal 20. Based on the screen information of the login screen 600, the screen display unit 210 of the user terminal 20 displays the login screen 600 on the display device 506.

In step S2, the user terminal 20 transmits a request to authenticate the user U to the scanner apparatus 10 in response to an operation performed by the user U. The operation performed by the user U is an operation of inputting the user account and the password on the login screen 600. The request to authenticate the user U includes the user account and the password input on the login screen 600. Based on the request to authenticate the user U, the scanner apparatus 10 performs authentication of the user U. The description is continued on the assumption that the authentication is successful.

When the authentication of the user U is successful, the screen transmission unit 110 of the scanner apparatus 10 transmits screen information of the home screen 610 to the user terminal 20. Based on the screen information of the home screen 610, the screen display unit 210 of the user terminal 20 displays the home screen 610 on the display device 506.

In step S3, the user terminal 20 transmits a request to acquire the job setting screen 700 to the scanner apparatus 10 in response to an operation performed by the user U. The operation performed by the user U is an operation of pressing the create button 632, the edit button 633, or the reference create button 634 in the content area 612 of the home screen 610. In response to the request to acquire the job setting screen 700, the scanner apparatus 10 transmits screen information of the job setting screen 700 to the user terminal 20. Based on the screen information of the job setting screen 700, the screen display unit 210 of the user terminal 20 displays the job setting screen 700 on the display device 506.

Specifically, the screen transmission unit 110 reads definition information from the storage unit 100. Based on the definition information, the screen transmission unit 110 generates screen information for rendering the overview screen 710. For example, the screen transmission unit 110 arranges the function areas 711 in the execution order indicated by the definition information in a predetermined direction and links the function areas 711 to each other. The screen transmission unit 110 also arranges, inside each of the function areas 711, the process areas 712 representing the processes classified into the function in a predetermined direction and links the process areas 712 to each other.

In response to the edit button 633 or the reference create button 634 being pressed on the home screen 610, the screen transmission unit 110 reads job information from the storage unit 100. Based on the job information, the screen transmission unit 110 sets the process areas 712 representing processes to be executed and the process areas 712 representing processes not to be executed in different display manners. Based on the job information, the screen transmission unit 110 sets the function areas 711 each representing a function for which none of the processes is executed and the function areas 711 each representing a function for which at least one of the processes is executed in different display manners.

In step S4, the user terminal 20 receives input of job information in response to an operation performed by the user U. The operation performed by the user U may include an operation of inputting setting information related to a process on the setting screen 720. The user terminal 20 transmits a job setting request to the scanner apparatus 10. The job setting request includes the job information input on the setting screen 720.

In step S5, the scanner apparatus 10 receives the job setting request from the user terminal 20. Based on the job setting request, the job management unit 120 of the scanner apparatus 10 determines whether a similar job has been set.

Specifically, the job management unit 120 first reads job information related to set jobs from the storage unit 100. The job management unit 120 then compares the job information included in the job setting request with each piece of job information read from the storage unit 100. For example, if the number of setting items having different setting values between the job information included in the job setting request and the read job information is less than or equal to a predetermined number, the job management unit 120 may determine that the corresponding jobs are similar to each other. The predetermined number may be, for example, 2. In another example, if a percentage of setting items having the same setting values between the job information included in the job setting request and the read job information is equal to or greater than a predetermined value, the job management unit 120 may determine that the corresponding jobs are similar to each other. The predetermined value may be, for example, 98%.

When the job management unit 120 determines that a similar job has been set (YES in step S5), the process proceeds to step S6. When the job management unit 120 determines that no similar job has been set (NO in step S5), the process skips step S6 and proceeds to step S7.

In step S6, the job management unit 120 of the scanner apparatus 10 transmits, to the user terminal 20, a notification indicating that a similar job has been set. In response to the notification from the scanner apparatus 10, the user terminal 20 notifies the user U that a similar job has been set. For example, the user terminal 20 may display a message indicating that a similar job has been set on the job setting screen 700. Alternatively, for example, the user terminal 20 may notify the user U that a similar job has been set by an icon, an image, a video, or sound.

In step S7, the job management unit 120 of the scanner apparatus 10 stores, in the storage unit 100, the job information included in the job setting request received in step S5. When the job management unit 120 determines in step S5 that a similar job has been set, step S7 may be skipped. When the job management unit 120 determines in step S5 that a similar job has been set, the job management unit 120 may make an inquiry of the user terminal 20 as to whether to store the job information. The user terminal 20 may instruct the scanner apparatus 10 whether to store the job information in response to an operation performed by the user U.

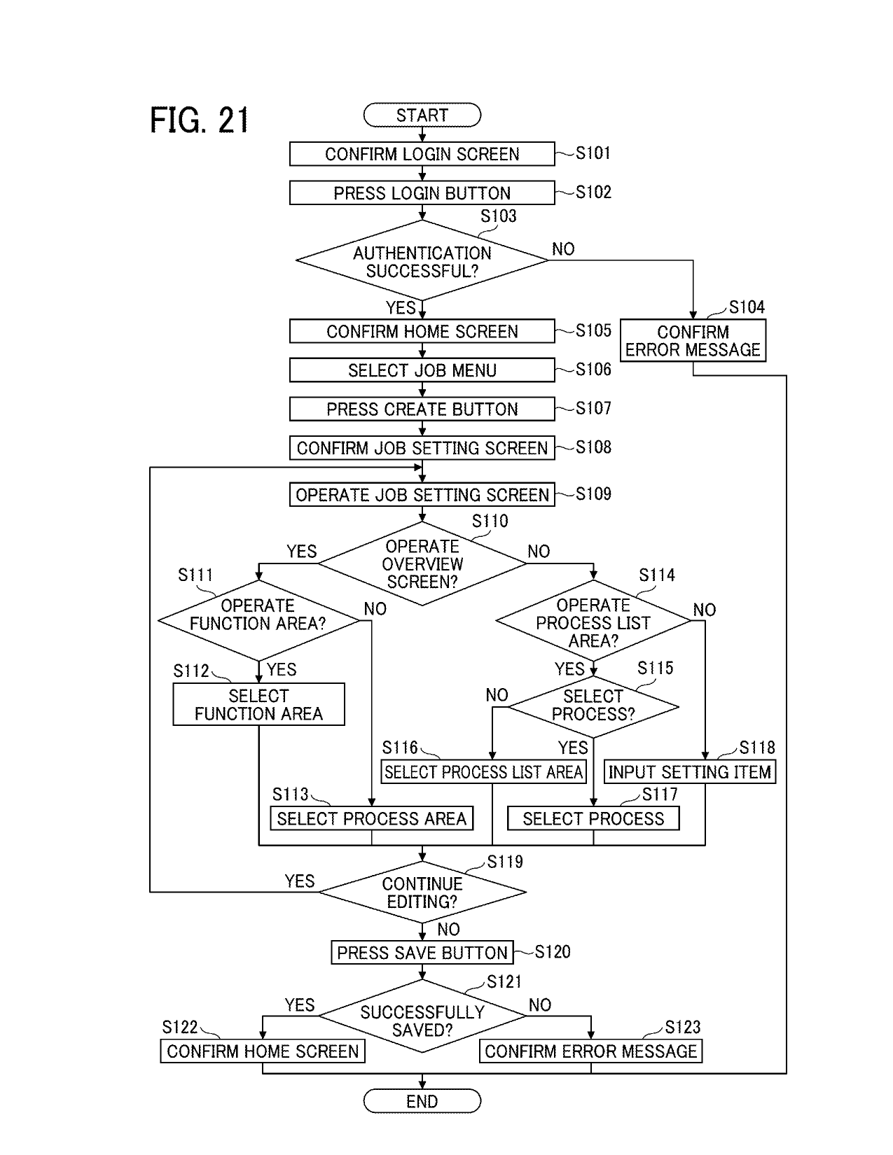

FIG. 21 is a second flowchart of an example of the job setting process. FIG. 21 illustrates an operation procedure of the user U in the job setting process.

In step S101, the user U confirms that the login screen 600 is displayed on the display device 506 of the user terminal 20. In step S102, the user U inputs the user account and the password on the login screen 600 and presses the login button 603. In step S103, the user U determines whether authentication is successful. When the authentication is successful (YES in step S103), the process proceeds to step S105. When the authentication is unsuccessful (NO in step S103), the process proceeds to step S104. In step S104, the user U confirms an error message, displayed on the login screen 600, indicating that the authentication is unsuccessful.

In step S105, the user U confirms that the home screen 610 is displayed on the display device 506 of the user terminal 20. In step S106, the user U selects the job menu 621 in the menu area 611 of the home screen 610. In step S107, the user U presses the create button 632 in the content area 612 of the home screen 610. In step S108, the user U confirms that the job setting screen 700 is displayed on the display device 506 of the user terminal 20.

In step S109, the user U performs an operation on the job setting screen 700. In step S110, the user U decides which of the overview screen 710 and the setting screen 720 to operate. When the user U decides to operate the overview screen 710 (YES in step S110), the process proceeds to step S111. When the user U decides to operate the setting screen 720 (NO in step S110), the process proceeds to step S114.

In step S111, the user U decides which of the function areas 711 and the process areas 712 to operate on the overview screen 710. When the user U decides to operate the function areas 711 (YES in step S111), the process proceeds to step S112. When the user U decides to operate the process areas 712 (NO in step S111), the process proceeds to step S113. In step S112, the user U selects one of the function areas 711. In step S113, the user U selects one of the process areas 712.

In step S114, the user U decides which of the process list area 721 and the setting input area 722 to operate on the setting screen 720. When the user U decides to operate the process list area 721 (YES in step S114), the process proceeds to step S115. When the user U decides to operate the setting input area 722 (NO in step S114), the process proceeds to step S118. In step S115, the user U decides whether to select a process in the setting input area 722. When the user U decides to select a process (YES in step S115), the process proceeds to step S117. When the user U decides not to select a process (NO in step S115), the process proceeds to step S116. In step S116, the user U sets the process list area 721 in a state where none of the processes is selected. In step S117, the user U selects a process in the process list area 721. In step S118, the user U inputs a setting item in the setting input area 722.

In step S119, the user U decides whether to continue editing. When the user U decides to continue editing (YES in step S119), the process returns to step S109. When the user U decides not to continue editing (NO in step S119), the process proceeds to step S120.

In step S120, the user U presses a save button 725 provided on the job setting screen 700. In step S121, the user U determines whether saving is successful. When the saving is successful (YES in step S121), the process proceeds to step S122. When the saving is unsuccessful (NO in step S121), the process proceeds to step S123. In step S122, the user U confirms that the home screen 610 is displayed on the display device 506 of the user terminal 20. In step S123, the user U confirms an error message, displayed on the job setting screen 700, indicating that the saving is unsuccessful.

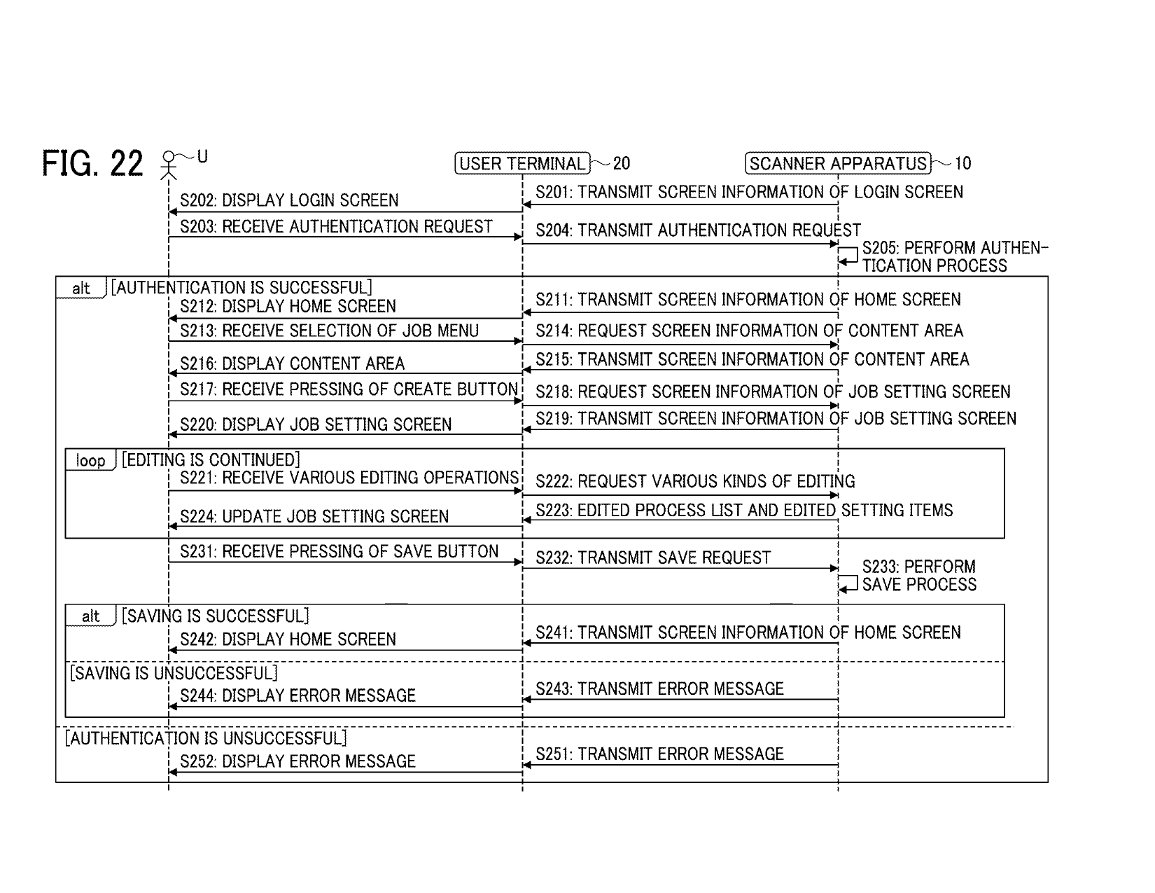

FIG. 22 is a first sequence diagram illustrating an example of the job setting process. FIG. 22 illustrates a relationship between an action of the user terminal 20 that is operated by the user U and an action of the scanner apparatus 10 in the job setting process.

In step S201, the scanner apparatus 10 transmits screen information of the login screen 600 to the user terminal 20. In step S202, the user terminal 20 displays the login screen 600 on the display device 506. The user U inputs the user account and the password on the login screen 600 and presses the login button 603. In step S203, the user terminal 20 receives an authentication request including the user account and the password input by the user U. In step S204, the user terminal 20 transmits the authentication request from the user U to the scanner apparatus 10. In step S205, the scanner apparatus 10 performs authentication of the user U based on the authentication request from the user U. When the authentication is successful, the process proceeds to step S211. When the authentication is unsuccessful, the process proceeds to step S251.

The authentication of the user U may be performed by an external apparatus of the scanner apparatus 10, such as a server. In this case, the scanner apparatus 10 transmits the authentication request received from the user terminal 20, to the external apparatus. The external apparatus performs authentication of the user U based on the authentication request received from the scanner apparatus 10 and transmits a result of the authentication to the scanner apparatus 10. Based on the authentication result received from the external apparatus, the scanner apparatus 10 determines whether the authentication of the user U is successful.

In step S211, the scanner apparatus 10 transmits screen information of the home screen 610 to the user terminal 20. In step S212, the user terminal 20 displays the home screen 610 on the display device 506. In step S213, the user terminal 20 receives selection, by the user U, of the job menu 621 in the menu area 611 of the home screen 610. In step S214, the user terminal 20 requests the scanner apparatus 10 to transmit screen information of the content area 612. In step S215, the scanner apparatus 10 transmits the screen information of the content area 612 to the user terminal 20. In step S216, the user terminal 20 displays the content area 612 on the home screen 610.

In step S217, the user terminal 20 receives pressing, by the user U, of the create button 632 in the content area 612 of the home screen 610. In step S218, the user terminal 20 requests the scanner apparatus 10 to transmit screen information of the job setting screen 700. In step S219, the scanner apparatus 10 transmits the screen information of the job setting screen 700 to the user terminal 20. In step S220, the user terminal 20 displays the job setting screen 700 on the display device 506.

In step S221, the user terminal 20 receives various editing operations performed by the user U on the job setting screen 700. In step S222, the user terminal 20 transmits an editing request based on the editing operation performed by the user U to the scanner apparatus 10. In step S223, the scanner apparatus 10 transmits screen information including an edited process list and edited setting items to the user terminal 20. In step S224, the user terminal 20 displays the edited process list and the edited setting items on the job setting screen 700. Steps S221 to S224 are repeatedly performed every time the user terminal 20 receives an editing operation performed by the user U.

In step S231, the user terminal 20 receives pressing, by the user U, of the save button 725 on the job setting screen 700. In step S232, the user terminal 20 transmits a job save request to the scanner apparatus 10. In step S233, the scanner apparatus 10 stores the job information in the storage unit 100. When the saving is successful (YES in step S233), the process proceeds to step S241. When the saving is unsuccessful (NO in step S233), the process proceeds to step S243.

In step S241, the scanner apparatus 10 transmits the screen information of the home screen 610 to the user terminal 20. In step S242, the user terminal 20 displays the home screen 610 on the display device 506.

In step S243, the scanner apparatus 10 transmits an error message indicating that the saving is unsuccessful to the user terminal 20. In step S244, the user terminal 20 displays the error message indicating that the saving is unsuccessful on the job setting screen 700.

In step S251, the scanner apparatus 10 transmits an error message indicating that the authentication is unsuccessful to the user terminal 20. In step S252, the user terminal 20 displays the error message indicating that the authentication is unsuccessful on the login screen 600.

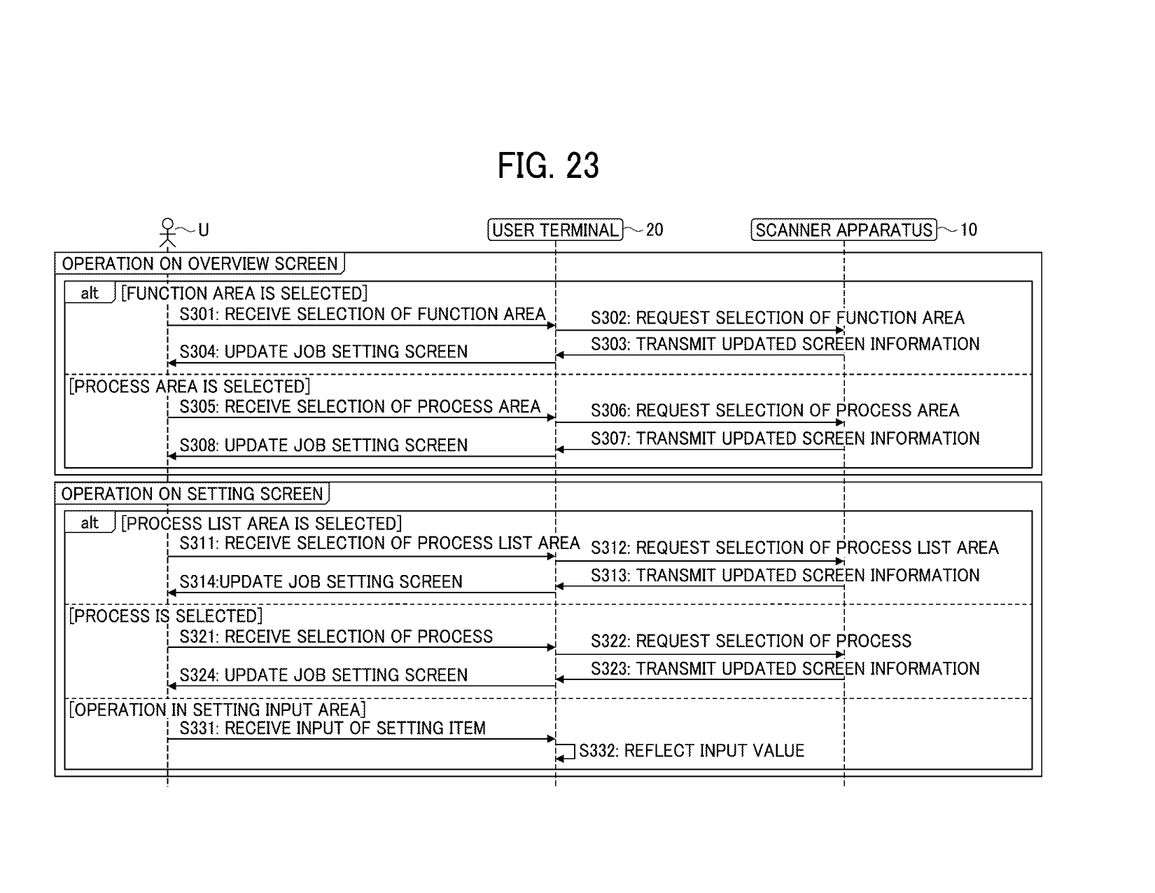

FIG. 23 is a second sequence diagram illustrating an example of the job setting process. FIG. 23 illustrates a relationship between an operation by the user U and an action of the scanner control system 1000 when a set job is edited. The sequence diagram illustrated in FIG. 23 corresponds to steps S221 to S224 illustrated in FIG. 22.

In step S301, the user terminal 20 receives selection, by the user U, of one of the function areas 711 on the overview screen 710 of the job setting screen 700. In step S302, the user terminal 20 transmits a request to select the function area 711 to the scanner apparatus 10. In step S303, the scanner apparatus 10 transmits screen information of the job setting screen 700 in which the function area 711 is selected, to the user terminal 20. In step S304, the user terminal 20 updates the job setting screen 700 to a state in which the function area 711 is selected based on the screen information. On the updated job setting screen 700, the setting input area 722 displays input fields for receiving setting information related to all the processes classified into the function corresponding to the selected function area 711.

In step S305, the user terminal 20 receives selection, by the user U, of one of the process areas 712 on the overview screen 710 of the job setting screen 700. In step S306, the user terminal 20 transmits a request to select the process area 712 to the scanner apparatus 10. In step S307, the scanner apparatus 10 transmits screen information of the job setting screen 700 in which the process area 712 is selected, to the user terminal 20. In step S308, the user terminal 20 updates the job setting screen 700 to a state in which the process area 712 is selected. On the updated job setting screen 700, the setting input area 722 displays input fields for receiving setting information related to the process corresponding to the selected process area 712.

In step S311, the user terminal 20 receives selection, by the user U, of the process list area 721 on the setting screen 720 of the job setting screen 700. In step S312, the user terminal 20 transmits a request to select the process list area 721 to the scanner apparatus 10. In step S313, the scanner apparatus 10 transmits screen information of the job setting screen 700 in which the process list area 721 is selected, to the user terminal 20. In step S314, the user terminal 20 updates the job setting screen 700 to a state in which the process list area 721 is selected. On the updated job setting screen 700, the setting input area 722 displays input fields for receiving setting information related to all the processes displayed in the process list area 721.

In step S321, the user terminal 20 receives selection, by the user U, of a process in the process list area 721 on the setting screen 720 of the job setting screen 700. In step S322, the user terminal 20 transmits a request to select the process to the scanner apparatus 10. In step S323, the scanner apparatus 10 transmits screen information of the job setting screen 700 in which the process is selected in the process list area 721, to the user terminal 20. In step S324, the user terminal 20 updates the job setting screen 700 to a state in which the process is selected in the process list area 721. On the updated job setting screen 700, the setting input area 722 displays input fields for receiving setting information related to the process selected by the user U.

In step S331, the user terminal 20 receives input, by the user U, of setting information to the setting input area 722 on the setting screen 720 of the job setting screen 700. In step S332, the user terminal 20 updates the job setting screen 700 to a state in which the setting information is input.

### Modifications

In the embodiment described above, the configuration has been described in which the scanner apparatus 10 and the user terminal 20 are connected to each other on a one-to-one basis, and the scanner apparatus 10 stores job information set in the scanner apparatus 10. In a modification, a configuration will be described in which a plurality of scanner apparatuses 10 store job information in an external storage device so that jobs set in the plurality of scanner apparatuses 10 are centrally managed.

The scanner control system 1000 according to the modification will be described below in terms of differences from the embodiment. The scanner control system 1000 according to the modification may be configured in the same manner as in the embodiment unless otherwise noted.

### General Arrangement

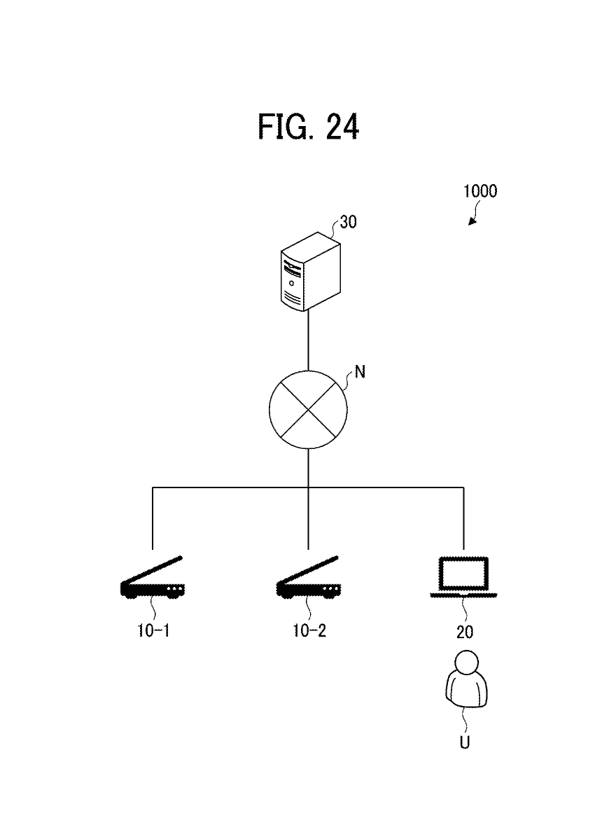

The general arrangement of the scanner control system 1000 according to the modification will be described with reference to FIG. 24. FIG. 24 illustrates an example of the general arrangement of the scanner control system according to the modification.

As illustrated in FIG. 24, the scanner control system 1000 includes a plurality of scanner apparatuses 10 (10-1 and 10-2), the user terminal 20, and a management server 30. The scanner apparatuses 10, the user terminal 20, and the management server 30 are connected to each other via the communication network N for data communication.

In the following description, when there are multiple scanner apparatuses 10, reference signs with suffixes are used for distinction, like “scanner apparatus 10-1” and “scanner apparatus 10-2”. When the term “scanner apparatus 10” without a suffix is used, the description thereof applies to all the scanner apparatuses 10.

The management server 30 is an example of an information processing apparatus that manages job information, such as a server, a workstation, or a personal computer. For example, the management server 30 has a hardware configuration illustrated in FIG. 2A. The management server 30 receives job information from each of the plurality of scanner apparatuses 10-1 and 10-2 and stores the job information in a storage device. In response to a request from the scanner apparatus 10, the management server 30 reads job information from the storage device and transmits the job information to the scanner apparatus 10.

### Functional Configuration

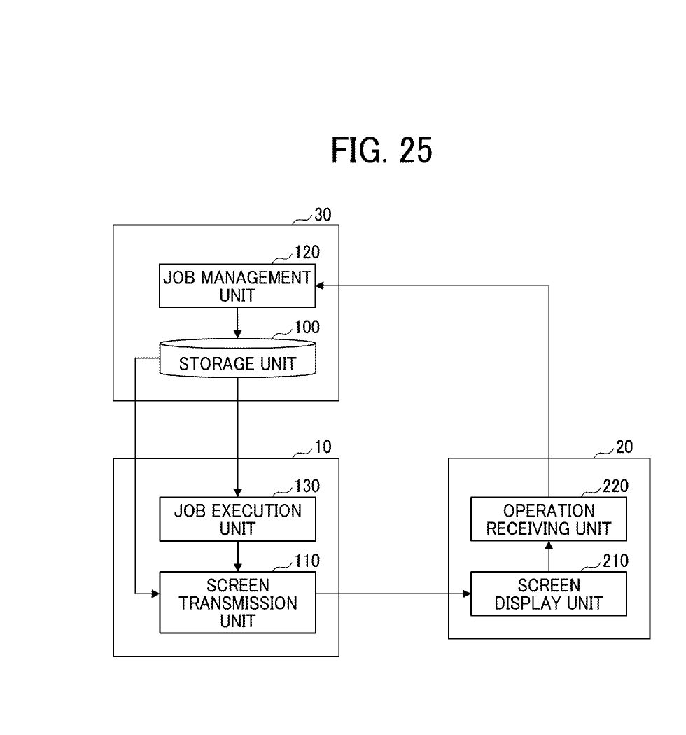

A functional configuration of the scanner control system 1000 according to the modification will be described with reference to FIG. 25. FIG. 25 is a block diagram illustrating an example of the functional configuration of the scanner control system according to the modification.

As illustrated in FIG. 25, the scanner apparatus 10 includes the screen transmission unit 110 and the job execution unit 130. The user terminal 20 includes the screen display unit 210 and the operation receiving unit 220. The management server 30 includes the storage unit 100 and the job management unit 120. That is, the scanner control system 1000 according to the present modification differs from that of the embodiment in that the management server 30 includes the storage unit 100 and the job management unit 120 included in the scanner apparatus 10 in the embodiment.

The storage unit 100 of the management server 30 stores job information received from each of the plurality of scanner apparatuses 10. The storage unit 100 of the management server 30 also stores history information received from each of the plurality of scanner apparatuses 10.

The job management unit 120 of the management server 30 centrally manages the jobs set in the plurality of scanner apparatuses 10. The job management unit 120 of the management server 30 may collectively store pieces of history information received from the plurality of scanner apparatuses 10 in the storage unit 100.

The job management unit 120 of the management server 30 may aggregate the utilization state of jobs. For example, the job management unit 120 may extract a popular job from among a plurality of jobs. Examples of the popular job may include a job for which the number of times reference creation is requested from the user terminal 20 is high or a job for which the number of times the job is set in batch processing is high.

The job management unit 120 may aggregate the utilization state of jobs for each group of jobs having similar purposes. For example, the job management unit 120 may acquire jobs with the output destination of “email” from among the plurality of jobs stored in the storage unit 100 and aggregate the utilization state of each group including the acquired jobs.

The job management unit 120 may aggregate the utilization state of the processes included in the jobs. For example, the job management unit 120 may extract a popular process from among a plurality of processes. Examples of the popular process may include a process included in a job with a high rate of execution among the plurality of jobs stored in the storage unit 100.

The screen transmission unit 110 of the scanner apparatus 10 may transmit screen information of the job setting screen 700 including the utilization state aggregated by the job management unit 120. For example, the screen transmission unit 110 may transmit screen information including the overview screen 710 indicating a popular job or a popular process.

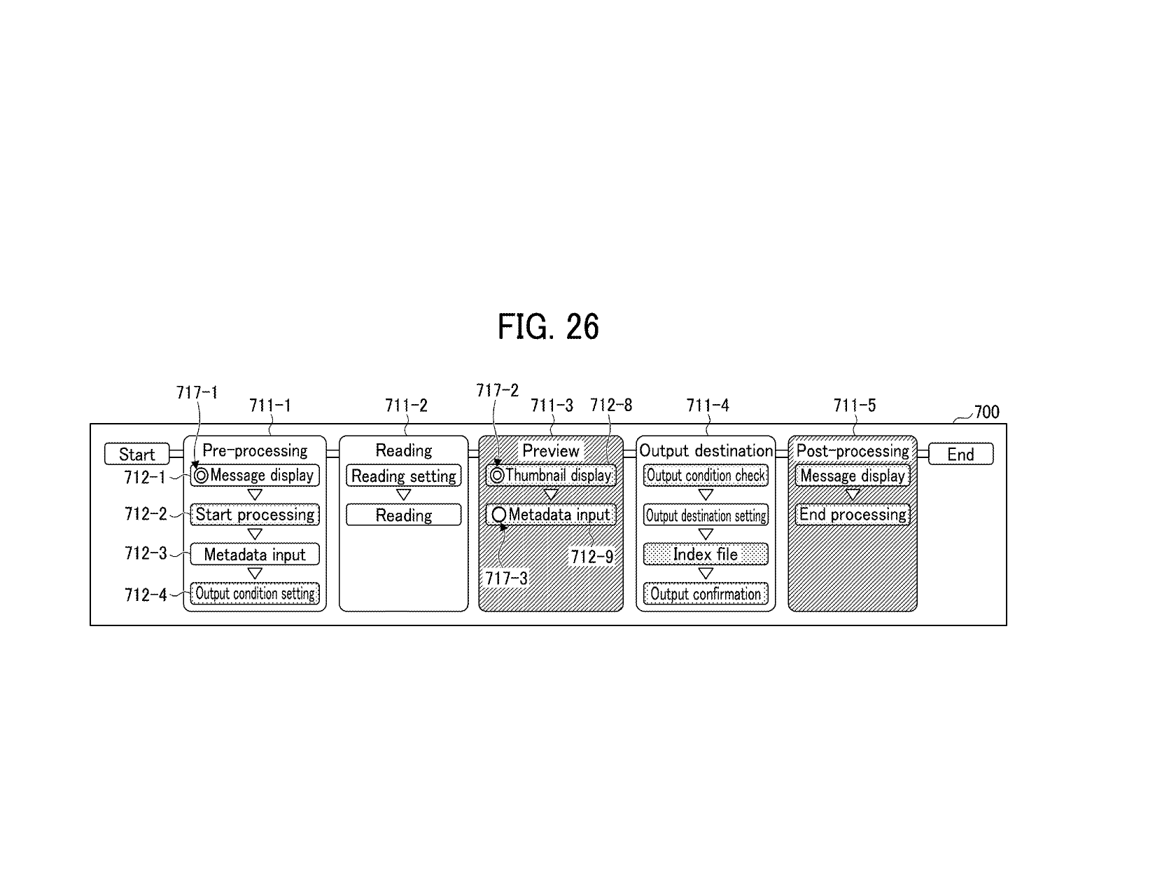

FIG. 26 is a diagram illustrating an example of the job setting screen according to the modification. FIG. 26 illustrates an example of the job setting screen 700 including the overview screen 710 indicating popular processes. As illustrated in FIG. 26, the overview screen 710 displays symbols 717 (717-1 to 717-3) indicating the popularity in the process areas 712 representing the popular processes.

The symbols 717 indicating the popularity may be changed in accordance with the degree of popularity. In the example illustrated in FIG. 26, a double circle indicates a particularly high popularity, and a single circle indicates a moderate popularity. For example, when a process is executed in 90% or more of all the jobs, the process is determined to have a particularly high popularity. When a process is executed in 60% or more and less than 90% of all the jobs, the process may be determined to have a moderate popularity.

A popular process is indicated on the overview screen 710. This allows the user U to easily understand the process that is highly likely to be useful among processes settable in a job. This can reduce the time for the user U with less experience in using jobs to set a job for executing appropriate processes.

A scanner apparatus 10 includes a screen transmission unit 110. The screen transmission unit 110 transmits screen information of a job setting screen 700 for setting a job that causes a plurality of processes to be executed in a predetermined order using the scanner apparatus 10. The plurality of processes are each classified into a function among a plurality of functions. The screen transmission unit 110 transmits the screen information for displaying function areas 711 arranged in an execution order of the plurality of functions, displaying process areas 712 arranged in an execution order of the plurality of processes inside the respective function areas 711 into which the plurality of processes are classified, and displaying an input field for receiving setting information indicating whether to execute the plurality of processes or description of the plurality of processes. In one aspect, in the present embodiment, since the overview of a job is displayed in units of functions and in units of processes, the convenience increases in setting a job.

The screen transmission unit 110 may transmit the screen information for simultaneously displaying an overview screen 710 that displays the function areas 711 and the process areas 712, and a setting screen 720 that receives input of the setting information related to the plurality of processes. In one aspect, in the present embodiment, since the setting information can be input with reference to the overview of the job, the convenience increases in setting a job.

The screen transmission unit 110 may transmit the screen information of the job setting screen 700 in which, among the process areas 712, a process area 712 representing the process to be executed and a process area 712 representing the process not to be executed are displayed in a different manner. In one aspect, in the present embodiment, the process to be executed and the process not to be executed are easily visually recognizable.

The screen transmission unit 110 may transmit the screen information of the job setting screen 700 in which, among the function areas 711, a function area 711 representing the function for which none of the processes is executed and a function area 711 representing the function for which at least one of the processes is executed are displayed in a different manner. In one aspect, in the present embodiment, the function to be executed and the function not to be executed are easily visually recognizable.

The setting screen 720 may display the input field for receiving the setting information related to the process represented by a process area 712 operated on the overview screen 710 among the process areas 712. In one aspect, in the present embodiment, a screen for receiving input of the setting information related to the process is easily displayable by an operation on the overview screen 710.

The setting screen 720 may display the input field for receiving setting information related to all the processes classified into the function represented by a function area 711 operated on the overview screen 710 among the function areas 711. In one aspect, in the present embodiment, a screen for receiving input of the setting information for the entire function is easily displayable by an operation on the overview screen 710.

The screen transmission unit 110 may transmit the screen information of the job setting screen 700 for receiving input to change a direction in which the function areas 711 are arranged or a direction in which the process areas 712 are arranged. In one aspect, in the present embodiment, the functions or processes are displayable in the execution order of the functions or processes in a given direction.

The screen transmission unit 110 may transmit the screen information of the job setting screen 700 in which the direction in which the function areas 711 are arranged or the direction in which the process areas 712 are arranged is changed in accordance with a screen display unit 210 of the user terminal 20. In one aspect, in the present embodiment, the overview of the job is displayable in an easy-to-visually-recognize manner in accordance with an environment in which the job setting screen 700 is displayed.

The functionality of the elements disclosed herein may be implemented using circuitry or processing circuitry which includes general purpose processors, special purpose processors, integrated circuits, application-specific integrated circuits (ASICs), digital signal processors (DSPs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An electronic apparatus comprising circuitry configured to:
generate screen information for setting a job that causes the electronic apparatus to execute a plurality of processes in a predetermined order, the plurality of processes being each classified into a function among a plurality of functions of the electronic apparatus,
the screen information causing a display to display one or more screens including:
first areas each representing a function among the plurality of functions, the first areas being arranged in an execution order of the plurality of functions;
second areas each representing a process among the plurality of processes, the second areas being arranged in an execution order of the plurality of processes inside the respective first areas each representing the function into which the process represented by each of the second areas is classified; and
an input field for receiving setting information indicating whether to execute the plurality of processes or description of the plurality of processes.

2. The electronic apparatus according to claim 1, wherein
the one or more screens include
a first screen that displays the first areas and the second areas, and
a second screen that displays the input field for receiving the setting information, and
the first screen and the second screen are simultaneously displayed.

3. The electronic apparatus according to claim 1, wherein among the second areas, a second area representing the process to be executed and a second area representing the process not to be executed are displayed in a different manner.

4. The electronic apparatus according to claim 3, wherein among the first areas, a first area representing the function for which none of the processes classified into the function is executed and a first area representing the function for which at least one of the processes classified into the function is executed are displayed in a different manner.

5. The electronic apparatus according to claim 2, wherein the second screen includes the input field for receiving the setting information related to the process represented by a second area operated on the first screen among the second areas.

6. The electronic apparatus according to claim 2, wherein the second screen includes the input field for receiving the setting information related to all the processes classified into the function represented by a first area operated on the first screen among the first areas.

7. The electronic apparatus according to claim 1, wherein the circuitry is configured to receive a change in a direction in which the first areas are arranged or a change in a direction in which the second areas are arranged, which is input via the one or more screens.

8. The electronic apparatus according to claim 7, wherein the circuitry is configured to generate the screen information such that the direction in which the first areas are arranged or the direction in which the second areas are arranged is changed in accordance with the display.

9. The electronic apparatus according to claim 1, further comprising:
the display configured to display the one or more screens.

10. An information processing system comprising:
the electronic apparatus according to claim 1; and
a user terminal communicably connected with the electronic apparatus via a network, the user terminal including
the display configured to display the one or more screens based on the screen information received from the electronic apparatus.

11. An information processing method comprising:
generating screen information for setting a job that causes an electronic apparatus to execute a plurality of processes in a predetermined order, the plurality of processes being each classified into a function among a plurality of functions of the electronic apparatus; and
displaying one or more screens on a display based on the screen information, wherein
the one or more screens includes:
first areas each representing a function among the plurality of functions, the first areas being arranged in an execution order of the plurality of functions;
second areas each representing a process among the plurality of processes, the second areas being arranged in an execution order of the plurality of processes inside the respective first areas each representing the function into which the process represented by each of the second areas is classified; and
an input field for receiving setting information indicating whether to execute the plurality of processes or description of the plurality of processes.

12. A non-transitory recording medium storing a plurality of instructions which, when executed by one or more processors, causes the one or more processors to perform an information processing method comprising:
generating screen information for setting a job that causes an electronic apparatus to execute a plurality of processes in a predetermined order, the plurality of processes being each classified into a function among a plurality of functions of the electronic apparatus; and
displaying one or more screens on a display based on the screen information, wherein
the one or more screens includes:
first areas each representing a function among the plurality of functions, the first areas being arranged in an execution order of the plurality of functions;
second areas each representing a process among the plurality of processes, the second areas being arranged in an execution order of the plurality of processes inside the respective first areas each representing the function into which the process represented by each of the second areas is classified; and
an input field for receiving setting information indicating whether to execute the plurality of processes or description of the plurality of processes.
